(19) United States
(12) Patent Application Publication
(10) Pub. No.: US 2022/0342401 A1
(43) Pub. Date: Oct. 27, 2022

(54) SYSTEMS AND METHODS FOR PRODUCTION-LINE OPTIMIZATION

(71) Applicant: Georgia-Pacific LLC, Atlanta, GA (US)

(72) Inventor: Adam C. Dunigan, Dunwoody, GA (US)

(73) Assignee: Georgia-Pacific LLC, Atlanta, GA (US)

(21) Appl. No.: 17/854,009

(22) Filed: Jun. 30, 2022

Related U.S. Application Data
(63) Continuation of application No. PCT/US2020/067747, filed on Dec. 31, 2020.
(60) Provisional application No. 62/956,517, filed on Jan. 2, 2020.

(51) Int. Cl. G05B 19/418

(52) U.S. Cl. CPC G05B 19/41865; G05B 2219/32015

(57) ABSTRACT

Systems and methods for production line optimization include: receiving, from each of a plurality of equipment along the production line, equipment data at each interval of a plurality of intervals, the equipment data including equipment speed data, equipment state data, and equipment fault data; analyzing the equipment data with one or more optimization rules to identify an optimization setting; and, outputting the optimization setting to a production line device for modification of the production line.

### CROSS-REFERENCE TO RELATED APPLICATIONS

This application is a continuation of PCT International Application PCT/US2020/067747 filed Dec. 31, 2020 (published Jul. 8, 2021, as WO 2021/138613), which, in turn, benefits from and claims priority to U.S. Provisional Patent Application Ser. No. 62/956,517, filed Jan. 2, 2020. The entire disclosures of which are incorporated by reference herein in their entirety as if fully set forth.

### TECHNICAL FIELD

The present systems and methods relate generally to evaluating production performance and identifying and implementing ideal production parameters on a production line.

### BACKGROUND

Typically, there are more opportunities towards improving a production line's performance than can be resourced. Previous approaches to production line monitoring and optimization fail to prioritize actionable steps towards improving production line performance in a most impactful and efficacious manner. Because actionable steps are not priority- or impact-ranked, previous approaches may result in inefficient maintenance practices, such as, for example, production line personnel over-allocating maintenance efforts towards issues that will not significantly impact performance, while ignoring minor, but accumulating, issues that may severely impact performance. The inefficiencies of previous approaches may not only impair production line performance, but may also increase safety risks for production line personnel, because the personnel may have to spend additional time servicing production line equipment to address issues with insignificant impact on performance.

Because a slight downward trend in performance can lead to large losses in throughput, early detection and mitigation of negatively impacting performance and fault trends can be pivotal to optimizing production line performance. Previous approaches may fail to adequately analyze historical production line data and, as a result, may fail to detect trends in production line performance, machine faults, and other factors that may indicate underlying and/or unaddressed production issues. Failure to identify performance and fault patterns in previous approaches can allow machine faults to accumulate and worsen, leading to decreasing throughput and potentially resulting in catastrophic failure of equipment.

Furthermore, physical inspection by a human operator of equipment along the production line often cannot identify minor faults that accumulate over time. Equipment may pause because it is starved, blocked, or otherwise faulted for any period. Short pauses are often either not visible to the operator, or ignored because they resolve prior to manual intervention by a human operator.

Therefore, there is a long-felt but unresolved need for a system or method that proactively monitors and analyzes production line data to determine optimal production line parameters, and identify and prioritize production line issues.

### BRIEF SUMMARY OF THE DISCLOSURE

Briefly described, and according to one embodiment, aspects of the present disclosure generally relate to systems and methods for evaluating production performance, determining optimal production performance and patterns, identifying and alerting towards production inefficiencies, and determining and reporting ideal production parameters.

As used herein, “equipment” generally refers to any machine, conveyor, or apparatus arranged on, or otherwise contributing to, a production line. For example, in a paper production line, equipment may include, but is not limited to, rewinders, logsaws, wrappers, case packers, palletizers, conveyors that convey materials therebetween, etc. As another example, a lumber mill may include tilt hosts, planers, unscramblers, trimmers, sorters, stackers, strappers, conveyors that convey materials therebetween, etc.

As used herein, “analyzer”, “engine”, or “tool” generally refers to a computing environment (or a collection thereof) that receives input and applies one or more processing techniques, programs, or applications to analyze the input and produce output. In various embodiments, an analyzer may include one or more servers for receiving and transmitting input and output, one or more processors that execute computer readable instructions for processing input and generating output (in addition to performing other functions), and one or more databases for storing and organizing input and output. In at least one embodiment, the one or more servers, the one or more processors, and/or the one or more databases may be centralized (e.g., at a single location or environment) or may be distributed, such as, for example, in one or more cloud-based computing environment. In one or more embodiments, the one or more servers, the one or more processors, and/or the one or more databases may be scalable computing environments where computing and/or storage capacity is increased in proportion to need. In at least one embodiment, an analyzer may refer to software that receives, processes, and analyzes input to generate output. For example, an analyzer may refer to software running on one or more networked computers that receive input from sensors monitoring equipment and other elements of a production line.

In one or more embodiments, the systems and methods described herein can include a complex assembly of digital analyzers, data analyses, and simulation software that provide unique and detailed insights to production line operations personnel or systems towards improving production throughput via control or insight into the production line in a quantified, prioritized manner. In at least one embodiment, the present systems and methods may utilize historized data of production line equipment data (e.g., equipment speeds, equipment faults, equipment states, production line layout, equipment SKU data, etc.) to perform actions including, but not limited to: 1) determining optimal equipment speed set-points as a function of reliability; 2) identifying trends in equipment faults and notifying operators of faulty equipment, or controlling such faulty equipment to mitigate such trends; 3) determining optimal equipment fault patterns; 4) providing recommended production line parameters by package format (e.g., a list of opportunities prioritized by throughput impact); 5) simulating package format/production line configuration changes to determine return on investment and optimal production scheduling; and 6) summarizing improvement opportunities into prioritized action lists in reports.

In at least one embodiment, the system can include one or more line definitions. The line definition allows the complex assembly of digital analyzers, data analysis, and simulation software to fully understand what equipment is upstream, and what equipment is downstream from a given equipment. Accordingly, equipment data received from each equipment may be time-correlated, and spatially correlated to allow the systems and methods herein to fully understand the impact of the equipment data in relation to the other equipment.

In various embodiments, a line definition data structure can include substructures for information including, but not limited to: 1) down code information, including down code keys, descriptions, and other information; 2) eater information (e.g., information related to machines that consume an intermediary output of a production line); 3) feeder information (e.g., information related to machines that provide intermediary outputs of a production line); 4) machine information, including machine line, name, type, make, model, buffer, and diversion information; 5) line information, including site key, line name, and complex key information; 6) site information, including site key and name information; 7) complex information, including site key, complex key, and name information; and 8) zone information, including line key, zone key, zone name, upstream, and downstream information. The line information may further include inferential detail. For example, a feeder may be inferred from a downstream eater (e.g., if equipment 2 is an eater to equipment 1, then equipment 1 must be a feeder-type equipment).

In various embodiments, the plurality of analyzers, services and/or applications can receive line definitions and equipment data from the data historian and/or other databases. In one or more embodiments, the plurality of tools, services, and/or applications may include, but are not limited to: 1) a material flow analyzer (MFA); 2) a reliability analyzer (RA) that includes fault trend analyses, like-asset comparisons, and a outlier and threshold alerting system; 3) a rate analyzer (RTA) that generates optimal speed determinations and increasing failure identifications; 4) machine configuration analysis tool that generates optimal recipe determinations, and includes a recipe change tracking system; 5) a bottleneck analyzer that formulates speed, downtime, and outright bottleneck determinations; and 6) a production line simulator. In at least one embodiment, the plurality of analyzers, services, and/or applications may perform actions including, but not limited to: 1) analyzing fault data and patterns to identify unnecessary starves and blocks on a production line; 2) comparing actual equipment rates to design rates to diagnose machine faults and optimize efficiency; 3) comparing adjacent rates of equipment on a production line to identify bottlenecks; 4) quantifying losses (e.g., productivity losses, resource losses, etc.) into units of production, fault counts, and/or durations; and 5) identifying and prioritizing opportunities to increase throughput.

In various embodiments, output of the system can include, but is not limited to: 1) lists of exceptions (e.g., violations) to predefined rules; 2) electronic communications, such as automated electronic alerts, texts, emails, etc.; 3) optimal equipment parameters, including recipes, speeds, and/or configurations; 4) bottleneck determinations; and 5) impact assessments, such as expected changes in throughput against actual changes in throughput. The system may organize and/or process output of analyzers described herein into one or more analytics output tables. For example, the system may organize bottleneck determinations from a bottleneck tool into a table of bottleneck determinations including identifying information for equipment analyzed to generate the determinations. In at least one embodiment, the system may process one or more analytics output tables to generate live, historical, and/or tool-specific data visualizations, as well as automated and ad-hoc reports. For example, the system may process changes to recipe parameters (from a recipe change tracking system and/or a simulation engine) and generate a scatter plot indicating changes in throughput, fault trends, and downtime that may occur should the recipe parameter changes be implemented in a physical production line.

In various embodiments, the system and elements thereof (e.g., analyzers, processes, etc.) are configured to transmit, communicate, and process information in shared input data tables and output tables. According to one embodiment, all input data is collected in a cloud storage environment (or other networked storage medium) and is retrieved from the cloud storage environment as-needed by the tools, processes, and other elements of the system. In one or more embodiments, because the input data is stored centrally and in a format useable by all system elements, the tools and processes described herein can function simultaneously (e.g., in parallel manner). In various embodiments, the tools, processes, and other system elements evaluate identical input data associated with identical time periods, but using disparate techniques to generate different outputs.

As an example, input fault data used for a reliability and rate analysis can be associated with a similar time period and can be identical to input used for an availability analysis. Once each analysis is complete, the output of each analysis (e.g., including any exceptions to preconfigured rules, policies etc.) are provided to a centralized output table that is structured such that each entry of output maintains table indexing schemas to allow reporting tools (described herein) to identify both the type of the output and the analyzer, process, or other system element that generated the output.

In one or more embodiments, the simulator described herein can utilize output sourced from disparate system analyzers and processes also discussed herein. In at least one embodiment, the simulator can generate ideal simulations of production lines (and/or equipment therein) that do not experience faults and operate under perfect conditions and parameters. In various embodiments, by seeding simulations with suboptimal parameters using output generated by other system elements and stored in a shared output table, the simulator can generate non-ideal, “faulted” simulations of the production lines, thereby allowing for simulation and evaluation of potential maintenance solutions towards fixing production lines and/or equipment that demonstrate faulted performance.

In one example, the system organizes all output as exceptions in an output table accessible to the simulator (e.g., and all other system elements). The simulator retrieves the output data from the output table in the form of exceptions, and seeds “faulted” production line simulations using the exceptions as a method of recreating faulted conditions experienced by actual production lines with which the output data is associated. In a data load phase, the simulator loads and seeds simulations with fault data, speeds, line definitions, and exceptions from stored input and output to simulate the current state of the production line as accurately as possible. Because the resultant simulations are representative of faulted performance of an actual production line, maintenance solutions (e.g., and/or impacts thereof on production line parameters) can be tested and evaluated before resources are expended on testing or implementing the maintenance solution on the actual production line.

In one or more embodiments, by performing functions and providing outputs herein, the system may yield improvements to areas including, but not limited to: 1) safety, because interactions between personnel and equipment may be reduced as a result of more prioritized and precise maintenance schedules; 2) uptime, because unnecessary stoppages on production lines may be reduced; 3) rate, because production lines may be debottlenecked; 4) reliability, because reduced starts and stops may allow for prolonged wear part lifetimes; 5) product quality, because of more consistent and controlled production line activities; 6) SKU optimization, because production line inefficiencies may be modeled, evaluated and addressed in simulations; and 7) project management focus areas, because maintenance efforts may be balanced between which issues are most readily fixable and which issues are most severely impactful.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 shows a diagram of an example system for production line optimization, in embodiments.

FIG. 2 shows a table of potential equipment data-points stored as equipment data, of FIG. 1.

FIG. 3 shows an example of how physical inspection of a logsaw may not allow for understanding of faults associated with that logsaw.

FIG. 4 depicts a material flow analyzer which is a component of analyzer of FIG. 1, in embodiments.

FIG. 5 depicts a reliability analyzer which is a component of analyzer of FIG. 1, in embodiments.

FIG. 6 shows an example fault graph showing increasing fault trend over a period, in an embodiment.

FIG. 7 depicts a rate analyzer which is a component of analyzer of FIG. 1, in embodiments.

FIG. 8 depicts a bottleneck analyzer which is a component of analyzer of FIG. 1, in embodiments.

FIG. 9 depicts a loss analyzer which is a component of analyzer of FIG. 1, in embodiments.

FIG. 10 depicts a graph showing example time-series buffer-fill data, which is an example of the equipment state data of FIG. 9, in embodiments.

FIG. 11 depicts the simulator of FIG. 1 in greater detail, in embodiments.

FIGS. 12-20 depict various visualizations output by the visualizer of FIG. 1, in embodiments.

FIG. 21 shows example equipment data, of FIG. 1, in the form of “missing roll” fault counts for a wrapper at daily intervals, in an embodiment.

FIGS. 22-27 respectively show a method for production line optimization, in embodiments, which are examples of the analyzer of FIG. 1.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

Aspects of the present disclosure generally relate to systems and methods for evaluating production performance, identifying production issues, and determining and implementing ideal production parameters.

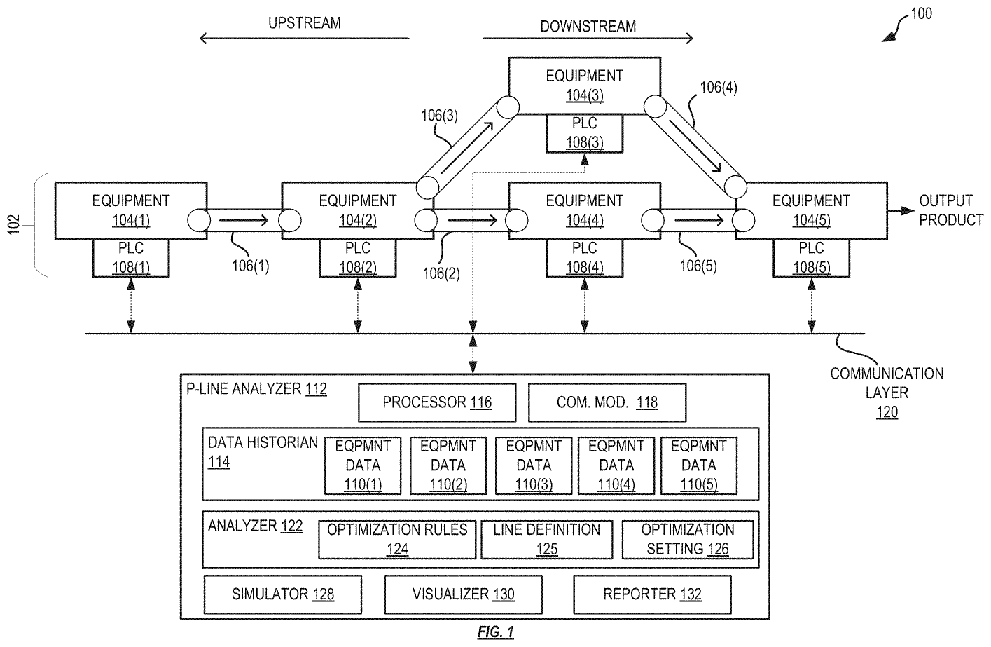

FIG. 1 shows a diagram of an example system 100 for production line optimization, in embodiments. System 100 shows a production line 102 having a plurality of equipment 104(1)-(5). As used herein, “production line” may refer to one or more pieces of equipment (e.g., machines, conveyors, etc.) that perform functions related to production and/or fabrication of an output product. FIG. 1 may only depict a portion of a production line. In embodiments, production lines may be grouped or assigned into one or more of zones, complexes (including a plurality of zones), and/or sites (including a plurality of complexes). In FIG. 1, “upstream” is to the left and “downstream” is to the right. The term “upstream” as used herein typically refers to the direction from a given point on the production line 102 towards a raw, or input, material. The term “downstream” as used herein typically refers to the direction from a given point on the production line 102 towards an output of the production line 102.

FIG. 1 shows five pieces of equipment 104, however a production line 102 may have more or fewer equipment without departing from the scope hereof. Equipment 104(3) and equipment 104(4) are “parallel” equipment to each other in that they each receive an input from the same equipment 104(2) and/or provide an output to the same equipment 104(5). Although each parallel stream includes only one equipment in FIG. 1, parallel equipment streams may include more than one equipment without departing from the scope hereof.

Material flows through the production line 102 via a plurality of conveyors 106(1)-(5). At each equipment 104, input material is conveyed from an upstream equipment via a conveyor 106, transformed by the given equipment 104 from one state to another state, and then conveyed to a downstream equipment 104 via another conveyor 106. Material flow is illustratively shown via arrows on each conveyor 106.

In at least one embodiment, each piece of equipment 104 (and, in embodiments, conveyor 106) may include a programmable logic controller (PLC) 108 that transmits equipment data 110 from production line and/or equipment sensors within each equipment 104 to a production line analyzer 112. The equipment data 110 may include metadata, assigned by the associated PLC 108, including machine tags and other classifiers to sensor data, thereby associating the sensor data with particular equipment and time of sensing, a particular production line, etc., and also providing metadata that the production line analyzer 112 utilizes for organizing and tracking the sensor data within a data historian 114. The metadata includes, for example: equipment description data such as (but not limited to): equipment_key, equipment_location, equipment_site, equipment_zone, equipment_upstream, equipment_downstream, equipmenttag_type, equipmenttag_tag, equipmenttag_description, equipment_name, equipment_type, equipment_make, equipment_model; equipment fault data such as (but not limited to): equipmentcode_type, equipmentcode_code, equipmentcode_description, equipmentcode_defaulttomit, equipmentfault_description; equipment state data such as (but not limited to): equipment_isbuffer, equipment_capacity, equipment_restartlevel, equipemnt_isdivert, divert_mode, etc. As an example, equipment data 110 for a given equipment within a paper machine (e.g., on a production line) can associate all generated sensor data with metadata including tags and other classifiers from the data scheme in FIG. 1. In the same example, the programmable logic controller can assign, to the sensor data, metadata including, but not limited to: 1) a machine tag; 2) a production line tag; 3) a zone tag; 4) a complex tag; 5) a site tag; and 6) other descriptive tags that identify the paper machine and/or serve to describe a status thereof (e.g., the paper machine is down, the paper machine provides input or “feeds” a particular machine, the paper machine receives input or “eats” from a particular machine, etc.).

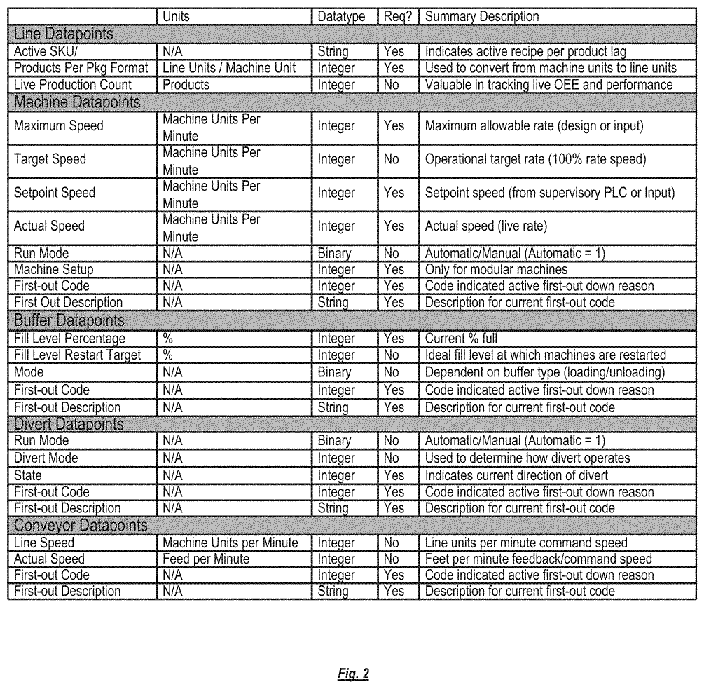

FIG. 2 shows a table of potential equipment data-points stored as equipment data 110, of FIG. 1. It should be appreciated that the listing of potential datapoints in FIG. 2 is an example only, and is not all-encompassing of the types and potential datapoints used in system 100. The equipment data may differ depending on one or more of the particular application of system 100, particular output for the production line 102, equipment 104 forming the production line 102, and information available from each PLC 108 associated with each equipment 104. Thus, in one embodiment, the stored equipment data 110 includes detail, regarding each equipment such as equipment state data including any one or more of: downtime data, downtime descriptions, uptime data, uptime descriptions, set-point speeds, target speeds (dynamic or manual entry), machine unites to line unit conversions (e.g., cases per minute to bottles per minute), manual mode, automatic mode, accumulator fill percentage (for buffer-type equipment), fill level restart target (for buffer-type equipment), loading or unloading mode (for buffer-type equipment), command speed in line units (for conveyor equipment), actual speed in line units (for conveyor equipment), production line data such as SKU/Package formats, production densities, production output, other equipment state data, and any combination thereof.

The stored equipment data 110 may include a first-in-first-out registered fault code at the PLC associated with specific faults in the machine that resulted in an undesired change in operation of the equipment.

The production line analyzer 112 may include a processor 116, and a communication module 118, that couples to each PLC 108 (which includes a respective processor and communication module) via a communication layer 120. The communication layer 120, in conjunction with the communication module 118 (and respective communication module of the PLCs 108) implements a communication protocol, which may be wired or wireless, to provide for communication between individual components within system 100. Accordingly, each PLC 108 may not only communicate through the communication layer 120 to the production line analyzer 112, but also to other components such as other PLCs. Such distributed communication provides for distributed computing embodiments where the functionality of system 100 discussed herein not only resides via execution of analyzers within the production line analyzer 112, or a cloud computing device, but also via analyzers that are distributed throughout the PLCs 108 and other computing devices at or remote from the production line 102. The communication layer 120, and configuration and administrative rights of various components of the system 100, may also implement, or otherwise adhere to, required industrial security protocols, such as but not limited to the Purdue Model for ICS security.

The equipment data 110 is stored in a data historian 114. In various embodiments, the data historian 114 may include physical and/or cloud-based storage entities, such as, for example, physical databases and/or cloud-based databases. In at least one embodiment, the data historian 114 may store data in an on-change, time-series format. The equipment data 110 may include equipment speed data, equipment state data, and equipment fault data. The data within the data historian 114 is processed by an analyzer 122 according to one or more optimization rules 124 to produce an optimization setting 126. The optimization settings 126 may include, but are not limited to: 1) determining optimal equipment speed set-points as a function of reliability; 2) identifying trends in equipment faults and notifying operators of faulty equipment, or controlling such faulty equipment to mitigate such trends; 3) determining optimal equipment fault patterns and providing recommendations for modifying such faulty equipment; 4) providing recommended production line parameters by package format (e.g., a list of opportunities prioritized by throughput impact); 5) simulating package format/production line configuration changes to determine return on investment and optimal production scheduling; and 6) summarizing improvement opportunities into prioritized action lists in reports.

In at least some embodiments, the optimization rules 124 may rely on a line definition 125 identifying the physical layout of the production line 102. In various embodiments, the line definition 125 may refer to a series of tabular data structures that describe and define a production line (or performance thereof). In one or more embodiments, the line definition 125 can include, but is not limited to: 1) a sequence of operations occurring on a production line (e.g., for example, machine A outputs to machines B and C); 2) a map of data and/or data points (e.g., for example, historical downtime of machine A is stored at “Downtime_MachineA”); and 3) other production line information, such as, for example, descriptions and definitions of machine faults, processes, errors, etc. used to decipher the equipment data 110 received from the PLCs 108. As one example, other production line information can include a down code with a description “Machine Starved.” In various embodiments, the system may store line definitions 125 in the data historian (e.g., within databases included therein) and/or or one more databases/memory distinct therefrom.

In one or more embodiments, the line definition 125 defines information required for automatic and ad-hoc operation of the production line 102. For example, tables of the line definition 125 can define required information to (automatically and/or on an ad-hoc basis) generate actionable insights for site personnel towards improving production line and/or complex throughput.

In one or more embodiments, the analyzer 122 and optimization rules 124 described herein can include a complex assembly of digital tools, data analyses, and simulation software that provide unique and detailed insights to production line operations personnel or systems towards improving production throughput in a quantified, prioritized manner. The analyzer 122 is shown as an internal component to the production line analyzer 112, but it should be appreciated that the analyzer 122 may be remotely located, such as a component of a cloud computing configuration, where necessary data to implement the optimization rules 124 are transmitted from the data historian 114 to the analyzer 122, and the optimization setting(s) 126 are transmitted back to the production line analyzer 112 for implementation at the production line 102. Thus, in at least one embodiment, the system may include an integrated computing environment including all tools, services, functionality, and/or applications described herein (e.g., where the tools, services, and/or applications are configured for communications therebetween). In one example, the system may exist within front-end and back-end software (e.g., C#, PYTHON™, JavaScript™, etc.) as a configurable product running analyses and simulations against historical production line data to provide actionable insights within schedulable and ad-hoc reports.

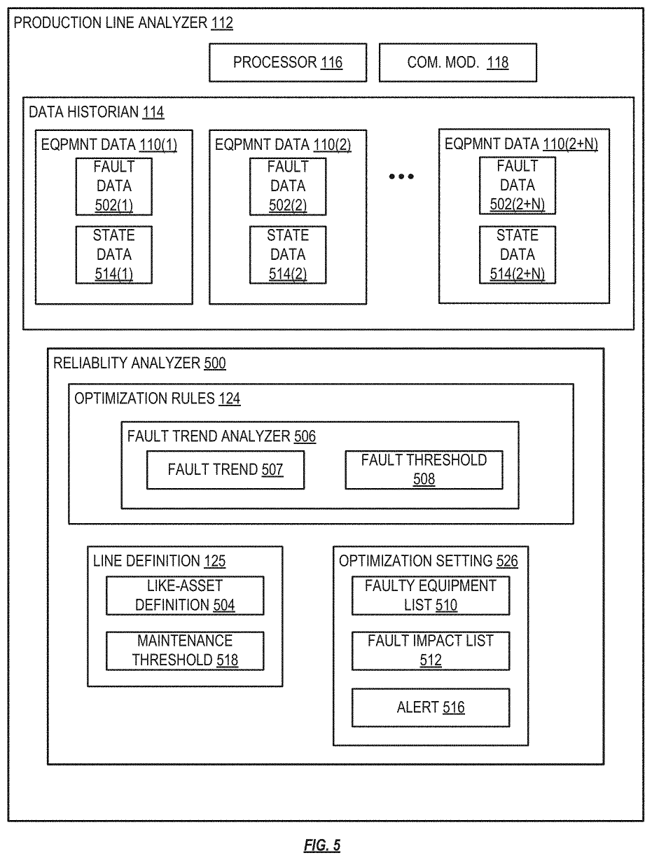

In various embodiments, the analyzer 122, and optimization rules 124, implements a plurality of services and/or applications including one or more of, but are not limited to: 1) a material flow analyzer (A/FA), such as that discussed below with respect to FIG. 4; 2) a reliability analyzer (RA) that includes fault trend analyses, like-asset comparisons, and/or a outlier and threshold alerting system; 3) a rate analyzer (RTA) that generates optimal speed determinations and increasing failure identifications; 4) machine configuration analyzer that generates optimal equipment setpoint determinations, and includes a setpoint change tracking system; 5) a bottleneck analyzer that formulates speed, downtime, and outright bottleneck determinations; and 6) a production line simulation tool. In at least one embodiment, the output optimization settings 126 include, but are not limited to: 1) analyzing fault data and patterns to identify unnecessary starves and blocks on a production line; 2) comparing actual equipment rates to design rates to diagnose machine faults and optimize efficiency; 3) comparing adjacent rates of equipment on a production line to identify bottlenecks; 4) quantifying losses (e.g., productivity losses, resource losses, etc.) into units of production, fault counts, and/or durations; and 5) identifying and prioritizing opportunities to increase throughput.

In at least one embodiment, a system tool may process all output with metadata included in input data from which the output was sourced. For example, if the equipment data 110 includes, a line_key, site_key, and equipment_name tag the system tool may assign matching metadata to all output optimization settings 126 sourced from such equipment data. In various embodiments, because all input data (e.g., equipment data 110) and output data (e.g., optimization settings 126) of the analyzer 122 is organized according to a standardized data scheme, the input and output of each algorithms implemented by the optimization rules 124 may be readily shared with and acted upon by all other system tools.

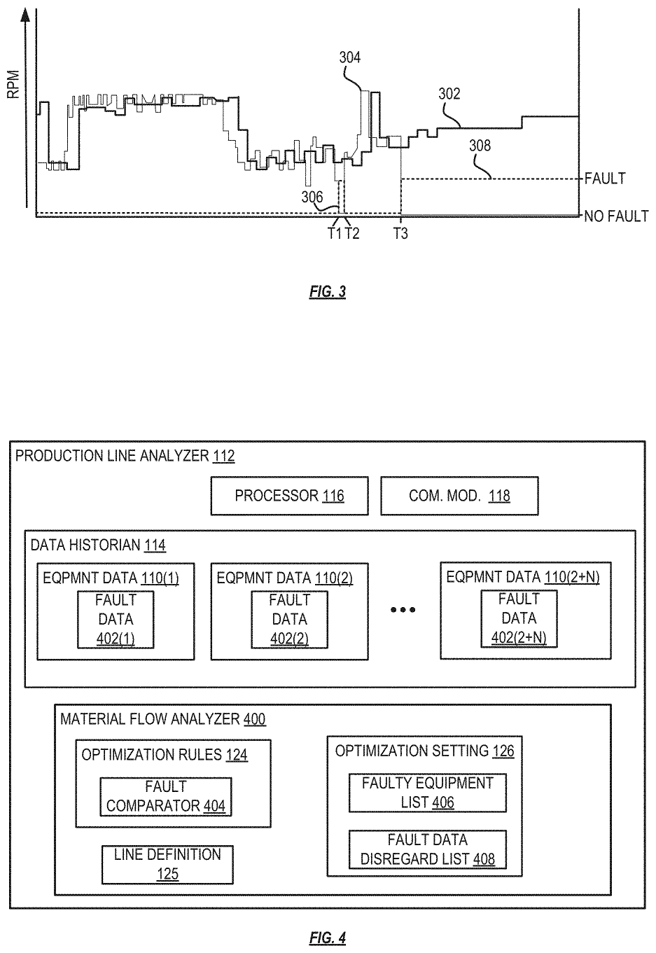

As discussed above, physical inspection by a human operator of equipment along the production line often cannot identify minor faults that accumulate over time. Equipment may pause because it is starved, blocked, or otherwise faulted for any period. Short pauses are often either not visible to the operator, or ignored because they resolve prior to manual intervention by a human operator. FIG. 3 shows an example of how physical inspection of a logsaw may not allow for understanding of faults associated with that logsaw. Line 302 depicts the control setpoint for the logsaw speed. Line 304 depicts the actual logsaw speed. At time T1 corresponding to fault 306, the actual speed 304 dips shortly, but then quickly rises consistent with the fault reversing at time T2. The operator, or a computer monitoring faults, may not trigger based on fault 306 because the fault code reverses and goes away at time T2, which is shortly after time T1. Fault 308, however, is noticeable because it results in a machine shutdown. Importantly, FIG. 3 only shows a single unnoticeable fault (fault 306). Many unnoticeable faults occurring over a period may accumulate and result in inefficient operation of the production line. The analyzer 122, via implementation of the optimization rules 124 and generation of the optimization setting 126, mitigates these inefficiencies by doing what the human operator cannot do—analyze the equipment data 110 in real time to make ad-hoc modifications to the production line 102 that account for not only critical faults in the equipment data 110, but also accumulation of minor faults that result in greater inefficiencies over a period.

### Material Flow Analysis

FIG. 4 depicts a material flow analyzer 400 which is a component of analyzer 122 of FIG. 1, in embodiments. Material flow analyzer 400 includes computer readable instructions that form at least a portion of the optimization rules 124 and, when executed by the processor 116, cause the processor 116 to implement the functionality of the material flow analyzer 400 discussed herein. For example, the material flow analyzer 400 monitors states of equipment (e.g., equipment 104) and conveyors (e.g., conveyors 106) operating on one or more production lines (e.g., production line 102). In one or more embodiments, the data historian 114 stores the equipment data 110 received from the one or more equipment 104 (and conveyor(s) 106). The equipment data 110 may include equipment fault data 402. Fault data 402 may include equipment fault data, such as but not limited to machine speed faults, states, jams, faults, and other data; and conveyor fault data such as, but not limited to conveyor speed faults, states, jams, faults, and other data. FIG. 4 shows equipment fault data (EF) for N+2 pieces of equipment, where N is an integer equal to or greater than 0. Equipment fault data 402(1) may be referenced as “EF₁”; equipment fault data 402(2) may be referenced as “EF₂”; and equipment fault data 402(2+N) may be referenced as “EF_{2+N}”. The equipment fault data 402 for each equipment may be time-correlated such that each fault, or fault state, is associated with a given time (e.g., initial time of fault, period of fault, time of resolution of fault).

The equipment analyzed by the material flow analyzer 400 includes not only equipment 104, but also conveyors 106. Conveyor jams are one example of material flow disruptions detectable by the material flow analyzer 400. However, some conveyor belt faults are not visible to the human operator. The material flow analyzer 400 allows for the production line analyzer 112 to identify inefficient control system logic (conveyors programmed poorly), equipment speed mismatches, failing eyes, failing conveyor drives, etc.

The optimization rules 124 may include a fault comparator 404. The fault comparator 404 analyzes the line definition 125 to identify, for each equipment 104 along the production line 102, upstream equipment and downstream equipment, of others of the plurality of equipment along the production line 102. By understanding the spatial relationship (e.g., upstream or downstream) of each equipment with respect to other equipment, the fault comparator 404 may determine whether the equipment data 110, and fault data 402 therein, correlates to one another.

In embodiments, the equipment fault data 402 defines whether each equipment 104 is running, faulted, starved, and blocked. In various embodiments, running can refer to equipment or conveyor operating within typical performance parameters, faulted can refer to a machine or conveyor operating outside typical performance parameters, starved can refer to a machine or conveyor operating outside typical performance parameters due to a lack of input material, and blocked can refer to a machine or conveyor operating outside of typical performance parameters due to an overabundance of output material.

The fault comparator 404 may determine if any given fault within the fault data 402 is not consistent with fault data from an upstream or downstream equipment. For example, if upstream equipment 104(1) is indicating a blocked state for a given period, then the equipment 104(2) downstream from equipment 104(1) should be either blocked or fault for no more than the given period. Continuing the same example, if the fault comparator 404 detects that the fault data 402(2) associated with equipment 104(2) is indicating a blocked state for a period more than the given period, the fault comparator 404 can determine that there is some faultiness of the equipment 104(2) that is unrelated to the status of equipment 104(1). The fault comparator 404 may also identify faulty equipment based on an upstream equipment indicating a starved state, and a downstream equipment indicating a blocked, or running state during the upstream equipment's starved state, or a starved state for a period greater than the period of the upstream equipment's starved state. If an equipment is identified as a faulty equipment, then the material flow analyzer 400 may output the optimization setting 126 including an identification of the faulty equipment in a faulty equipment list 406.

Furthermore, in one embodiment, the output optimization setting 126 is a fault data disregard list 408 of verified ones of the fault data 402 that may be disregarded by the analyzer 122 because it corresponds in time and/or type of fault to other ones of the fault data 402. If a given fault data 402 has a corresponding fault data from another equipment, as determined by the fault comparator 404, then that fault data may be disregarded by the analyzer 122 when implementing other analyzer algorithms because the fault is accounted for by the fault comparator 404. This results in fewer computations by the various optimization rules 124 discussed herein.

In one or more embodiments, the output optimization setting from the material flow analyzer 400 may be used by the production line analyzer 112 to perform one or more actions including, but not limited to: 1) generating and transmitting an exception event alert to a user; 2) updating one or more displays, graphical user interfaces (GUIs), or the like, to include a notification regarding the flagged exception event; 3) evaluating one or more elements of a production line, zone, complex and/or site where the exception event occurred to identify one or more causes or influences on the exception event; and 4) identifying, reporting, and/or executing one or more corrective steps to alter equipment performance and resolve the exception event.

In one or more embodiments, the output optimization setting from the material flow analyzer 400 may be used by the production line analyzer 112 analyze exception events to generate exception trends and identify potential issues in a production line. In at least one embodiment, the trends may indicate observations including, but not limited to: 1) where production line sensors may be faulty or failing; 2) where opportunities may exist in current control schema to avoid future rule violations and exception events; and 3) what changes may have been made to a production line that could have resulted in an identified equipment state, or exception event.

### Reliability Analysis (RA)

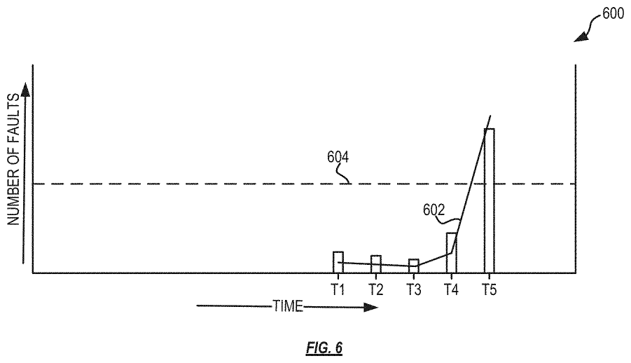

FIG. 5 depicts a reliability analyzer 500 which is a component of analyzer 122 of FIG. 1, in embodiments. The reliability analyzer 500 includes computer readable instructions that form at least a portion the optimization rules 124 and, when executed by the processor 116, cause the processor 116 to implement the functionality of the reliability analyzer 500 discussed herein. For example, the reliability analyzer 500 may monitor and evaluate downtime of equipment 104 and conveyors 106 operating on one or more production lines 102. In one or more embodiments, the reliability analyzer 500 may receive, process, and compare equipment data 110, such as equipment fault data 502 (which may be the same as equipment fault data 402 and the description of equipment fault data 402 applies to equipment fault data 502), to monitor machine downtime trends for changes in fault patterns, discrepancies in failure patterns between similar equipment (e.g., which may indicate similar equipment as equipment having the same make, model number, and/or SKU as a given piece of equipment), and for statistical outliers and/or threshold violations that may be predictive for identifying ongoing and/or imminent maintenance issues. In at least some embodiments, the equipment fault data 502 includes only the equipment faults that are not on the fault data disregard list 408, of FIG. 4.

In at least one embodiment, the line definition 125 includes a like-asset definition 504. The like-asset definition 504 may include a set of data defining associations between two or more pieces of production line equipment 104. In various embodiments, the like-asset definition 504 may define a set of criteria for determining if two pieces of equipment 104 can be considered “like assets.” For example, the like-asset definition 504 for a particular equipment may include a list of all serial numbers and/or model numbers of machines that may be considered a “like asset” to the particular piece of equipment. As another example, the like-asset definition 504 for a particular equipment may include a production task code (or other identifier) that identifies a function performed by the particular equipment. In the same or another example, the like-asset definition 504 may indicate that all equipment sharing the production task code (e.g., and performing functions analogous or identical to the particular machine) may be considered a like-asset to the particular equipment.

In one or more embodiments, the reliability analyzer 500 (and other tools and processes described herein) can evaluate the like-asset definition 504, and the active SKU and/or package format parameters defined therein, when performing comparisons between machines or on a single machine (e.g., on a temporal basis). In at least one embodiment, a product (defined by an active SKU) can dictate parameters of a production line and/or equipment therein and, accordingly, equipment directed towards a first product can be dissimilarly parametrized compared to second equipment directed towards a second product. Thus, in various embodiments, production line and equipment data is compared only in instances where the data is associated with equipment and production lines of shared active SKU and/or package format parameters.

As an example, if identical equipment A and equipment B are creating widget “abc” for 3 months, fault trends for both equipment A and B (which may be on the same production line, or different production lines) can be compared by the reliability analyzer 500 for the entirety of the 3 months as they are similar machines running the same product (widget abc). In the same example, the equipment A changes to creating widget “xyz” for in the next month (month 4) while equipment B stays on widget abc. Continuing the same example, the system may not compare fault trends for equipment A and equipment B for month 4, because the equipment A and B are now running different products and that can enable/disable/change how portions of the equipment behave and fail.

In various embodiments, the reliability analyzer 500 may, based on the optimization rules 124 implementing a fault trend analyzer 506, evaluate the equipment data 110 by performing one or more fault trend analyses. In at least one embodiment, the fault trend analyzer 506 may include, but is not limited to: 1) defining a historical norm for each fault of each equipment (e.g., in a production line); 2) receiving and processing fault data (e.g., fault data 502) to generate one or more fault trends; 3) comparing generated fault trends to defined historical norms of the given equipment, or like-assets to the given equipment, to identify deviations therefrom (e.g., increasing or decreasing fault frequency compared to a defined norm); and 4) in response to detecting fault trend deviations, flagging the fault trend, as part of the output optimization setting 526 (which is an example of the optimization setting 126 of FIG. 1), (and equipment-related data thereof) for further evaluation (e.g., by a system user, site personnel, etc.).

In one example, the reliability analyzer 500 receives the equipment fault data 502 for the plurality of equipment 104 in a production line 102. The equipment fault data 502 may be time-series data such that the equipment fault data 502 may be associated with a predefined historical production period, such as one month, one year, etc., and the current machine fault data may be associated with a predefined current production period, such as one day, one week, etc. In the same example, the reliability analyzer 500 processes the equipment fault data 502 of each equipment and defines a historical norm for each fault type of each equipment. Continuing the same example, the reliability analyzer 500 processes the equipment fault data 502 to generate a fault trend 507 for each equipment. In the same example, the reliability analyzer 500 compares the generated fault trend 507 to a fault threshold 508, and outputs the optimization setting including a list of faulty equipment 510 demonstrating a fault trend that breaches the fault threshold 508. In embodiments, the fault threshold 508 is the historical norm of the fault data 502 for a given machine over a given period. In embodiments, the fault threshold 508 is an expected frequency-rate being based on historical frequency of faults for the given equipment. In embodiments, the fault threshold 508 is an expected frequency-rate being based on historical frequency of faults for additional equipment (i) located at the production line or another production line, and (ii) being a like-asset to the given equipment.

In at least one embodiment, the reliability analyzer 500 generates a fault-impact list 512 to identify one or more most-impactful faults, fault trends, and/or fault patterns. For example, the reliability analyzer 500 may analyze fault data over a period (e.g., the span of a year) and determine a most-impactful fault by identifying a fault type that led to a highest average downtime and/or reduction to throughput. Accordingly, the reliability analyzer 500 may compare the time-correlated equipment fault data 502 to the time-correlated equipment state data 514 to determine impact of a given fault. In one or more embodiments, the reliability analyzer 500 may prioritize the fault-impact list 512 by comparing identified most impactful faults, fault trends, and/or fault patterns for equipment of a production line to identify a most-impactful production line fault, fault trend, and/or fault pattern. For example, the reliability analyzer 500 may identify a most-impactful fault for each piece of equipment 104 in a production line 102, impact being based on reduction to production throughput. In the same example, the reliability analyzer 500 may compare and rank the most-impactful faults to identify, flag, and report a most-impactful production line fault. Continuing the same example, the reliability analyzer 500 may output the ranking of most-impactful faults, thereby providing indication of which faults, fault types, trends, and/or patterns should be given priority during maintenance scheduling.

In at least one embodiment, the reliability analyzer 500 may evaluate data by comparing the equipment data 110 from a first equipment to equipment data of a second equipment that is similar to the first equipment as defined by the like-asset list 504. In one or more embodiments, the reliability analyzer 500 receives the like-asset definition list 504 that includes pre-defined sets of equipment of like make and/or model, and compares fault trend 507 data between equipment in the pre-defined sets to identify faults that are statistically variant from a best-performing machine of the pre-defined set. In at least one embodiment, in response to identifying a statistically variant fault, the reliability analyzer 500, or other system element, may output the faulty equipment list 510 or fault impact list 512 including one or more of: 1) logging the statistically variant fault for further investigation; 2) generating and transmitting one or more alerts; and 3) identifying and/or executing one or more corrective actions to mitigate the fault (e.g., by changing machine parameters, etc.). In various embodiments, like-asset list 504 includes pre-defined sets of machines may include machines within and/or across production lines, zones, complexes, and/or sites. For example, the reliability analyzer 500 may receive a pre-defined set of machines including all machines of identical make and model at a particular complex. In the same example, the reliability analyzer 500 can compare fault patterns of machines in the pre-defined set, and can identify and flag one or more machines demonstrating statistically variant fault types and/or fault patterns.

In one example, the reliability analyzer 500 receives the equipment fault data 502 for each equipment in a production line, and also receives the like-asset definition 504 including a set of like-asset definitions defining sets of equipment in which data of the equipment therein may be compared against each other. The equipment fault data 502 may be time-correlated such that it is associated with a predefined historical production period, such as one week, one month, one year, etc. In the same example, the reliability analyzer 500 processes the equipment fault data 502 of each machine and defines the fault trend 507 as an equipment historical norm for each fault type of each equipment. Continuing the same example, the reliability analyzer 500 identifies a best-performing equipment in each set of equipment by determining, for each set, the equipment demonstrating a lowest level of faults during the predefined historical production period. In the same example, for each set of machines, the reliability analyzer 500 compares the machine historical norms of each fault type of each machine to the corresponding machine historical norms of the identified best-performing machine. Continuing the same example, the reliability analyzer 500 flags machines with one or more machine historical norms that are statistically variant from the corresponding machine historical norms of the best-performing machine.

In one or more embodiments, the output optimization setting 526 from the reliability analyzer 500 includes, but is not limited to, one or more lists of downtime issues, such as rule exceptions, statistically variant faults and fault patterns, and/or threshold-satisfying or traversing faults and fault patterns. In various embodiments, the output optimization setting 526 may include equipment, production line, zone, complex, and site information, thereby allowing for identification of equipment, production lines, zones, complexes, and sites associated with the output data. In at least one embodiment, the output optimization setting 526 includes alerts, notifications, and/or other communications including and/or describing the output data.

In various embodiments, the output optimization setting 526 may output one or more identified downtime issues within the faulty equipment list 510 and/or fault impact list 512 to one or more system elements to generate production line, zone, complex, and/or site resource allocations. In at least one embodiment, the generated allocations may prioritize engaging maintenance issues that, if successfully addressed, that will return most optimal results in reducing or removing a given equipment from the faulty equipment list 510 and/or fault impact list 512 (e.g., such as, for example, minimized machine downtime, maximized production line speed, maximum production line debottlenecking, etc.). In one example, the RA tool may output identified downtime issues to bottleneck identification and production line simulation processes that further evaluate and model equipment associated with the downtime issues to focus site resources on the downtime issues that, if successfully addressed, will return the greatest results.

In various embodiments, the reliability analyzer 500 may output the optimization setting 526 including an alert 516 that automatically alert system users (e.g., site personnel, etc.) to identified faults and fault patterns. The alert 516 may be transmitted to the production line analyzer 112, or directly to operator devices, such as handheld tablets, e-mail, or other devices used by operators while managing the production line 102. In at least one embodiment, the reliability analyzer 500 may perform an outlier and threshold alerting process upon identifying one or more faults and/or fault patterns that indicate a risk of severe and/or imminent machine failure. In various embodiments, the reliability analyzer 500 may compare the fault trend 507 to the fault threshold 508 to predict and/or define a fault or fault pattern's risk (e.g., satisfaction and/or traversal of a threshold being indicative of severe and/or imminent failure). In one example, the fault threshold 508 includes a set of specific faults that, upon occurring in increasing frequency, can be indicative of a wear-part reaching the end of its life (e.g., due to degradation, etc.). In the same example, upon the reliability analyzer 500 determining that an equipment demonstrates the set of specific faults occurring in increasing frequency, the reliability analyzer 500 may determine the pre-defined threshold 508 to be satisfied and may transmit the alert 516 to one or more users describing the identified faults and potential indications therefrom. In various embodiments, alerting on a change in fault type and/or fault pattern can advantageously provide for proactive and efficient production line maintenance. For example, alerting on a change in fault pattern can assist maintenance personnel with identifying and replacing soon-to-fail wear parts, thereby advantageously avoiding unplanned downtime and/or additional machine faults.

In embodiments, the alert 516 may also implement automatic control. For example, the alert 516 may automatically initiate a maintenance order for the faulty equipment when the frequency of faults for the given equipment exceeds the expected frequency-rate of the respective equipment by a maintenance threshold 518.

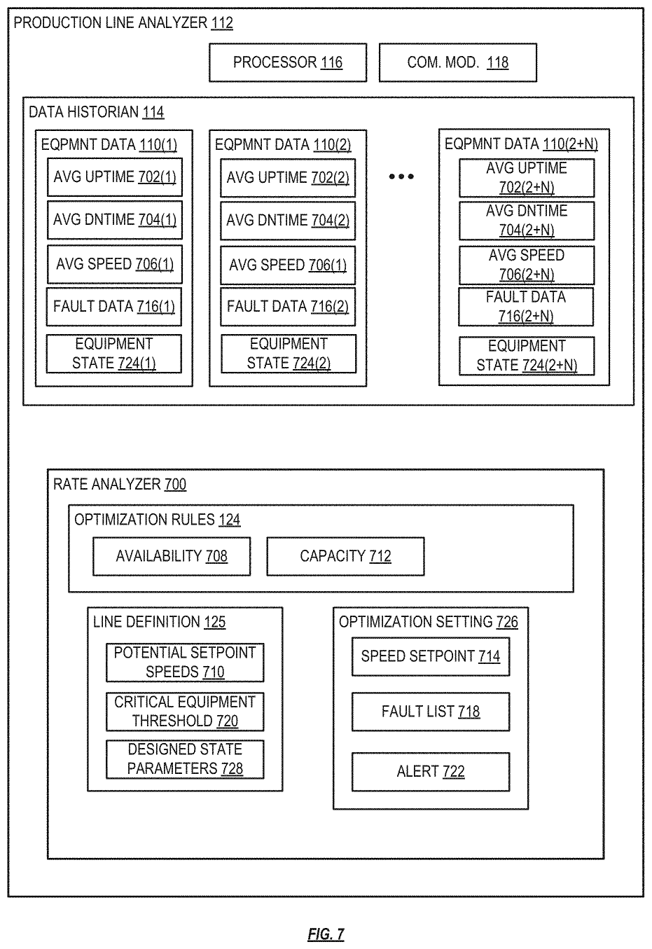

FIG. 6 shows an example fault graph 600 showing increasing fault trend over a period, in an embodiment. Graph 600 shows a count of faults on the Y-axis, and time on the X-axis. The time may be in days, hours, seconds, months, or any interval of time. As shown, for a majority of the period of time along the Y axis, the given equipment providing the fault data populating graph 600 has no faults. However, at time T1, the equipment starts faulting. Between time T1 and T3, the number of faults actually goes down, and fault trend line 602 (which is an example of fault trend 507 discussed above) has a negative slope. However, the number of faults at times T4 and T5 grows rapidly and between T4 and T5, the fault trend line 602 crosses fault threshold 604 (which is an example of fault threshold 508 discussed above). The fault threshold 604 (and thus fault threshold 508) is shown as a number of faults, but it may also be a slope of the fault trend line 602, or a percentage increase between a first time and a previous time, or any other metric used to determine if the fault trend is undesirable.

### Rate Analysis (RTA)

FIG. 7 depicts a rate analyzer 700 which is a component of analyzer 122 of FIG. 1, in embodiments. The rate analyzer 700 includes computer readable instructions that form at least a portion of the optimization rules 124 and, when executed by the processor 116, cause the processor 116 to implement the functionality of the rate analyzer 700 discussed herein. For example, the rate analyzer 700 monitors equipment speed and availability relations to identify at which speed the equipment is most efficient. In one or more embodiments, the rate analyzer 700 may receive equipment data 110 including, but not limited to: 1) equipment data, including fault data, speed data, and identifying information; 2) conveyor data, including fault data, speed data, and identifying information; and 3) production line, zone, complex, and/or site efficiency data, such as, for example, historical efficiency, speed, and production data.

In various embodiments, the equipment data 110 includes equipment state data including average uptime 702 and average downtime 704 of each equipment. Uptime may be defined as time that equipment is actively producing. Time that the equipment is starved, blocked, or otherwise paused time is excluded from uptime. Downtime is time equipment is in a faulted state, pause time is excluded. The equipment data 110 may further include equipment speed data including average speed 706.

The rate analyzer 700 determines the availability 708 of each equipment based on the equipment's respective average uptime 702 and average downtime 704 at each of a plurality of potential set-point speeds 710. The potential set-point speeds 710 may be defined in the line definition 125, where each equipment has a plurality of manufacturer-set speed options. For example, the availability 708 may be determined based on equation 1, below.

$$A v ailabilit {y}_{{E}_{i}} = \frac{Uptim {e}_{{E}_{i}}}{( Uptim {e}_{{E}_{i}} + Downtim {e}_{{E}_{i}} )} \qquad ( Eq . 1 )$$

The rate analyzer 700 determines the capacity 712 of each equipment based on the equipment's availability 708 and the given potential setpoint speed 710. Table 1, below, depicts an example of the rate analyzer 700 for a hypothetical piece of equipment.

TABLE 1
Rate Analysis Data:

| | | | | |
|---|---|---|---|---|
| Potential | 10 ppm | 20 ppm | 30 ppm | 40 ppm |
| Setpoint Speed | | | | |
| (710) | | | | |
| Availability | 98% | 95% | 90% | 65% |
| (708) | | | | |
| Capacity (712) | 9.8 ppm | 19 ppm | 27 ppm | 26 ppm |
| Uptime (702) | 980 minutes | 950 minutes | 900 minutes | 650 minutes |
| Downtime (704) | 20 minutes | 50 minutes | 100 minutes | 350 minutes |

The rate analyzer 700 may then output the optimization settings 726 (which are an example of the optimization setting 126 of FIG. 1) as a speed-setpoint 714 corresponding to one of the plurality of potential speed setpoints 710 that results in the greatest capacity for that equipment. In certain embodiments, the optimization settings 726 define speed setpoints 714 that include potential setpoints that summarize improvement opportunities into a prioritized action lists in the reports. Thus, the speed setpoint 714 may indicate an improvement in availability that will result in a greater capacity for each equipment.

In one or more embodiments, as described herein, the rate analyzer 700 can consider active SKU and/or package format (as defined in the line definition 125) information to ensure meaningful comparisons can be made between equipment and/or production lines. In at least one embodiment, a meaningful comparison generally refers to comparisons between or within equipment and/or production lines, wherein the equipment and/or production lines being compared are directed towards similar and/or identical products (e.g., as indicated by shared active SKU and/or package format information). In various embodiments, a meaningful comparison can also generally refer to evaluating equipment parameters based on active SKU and/or package format information associated with the equipment parameters.

As one example, when evaluating equipment speeds of a first equipment, the rate analyzer 700 considers design speeds of the first equipment as a function of active SKU information. The rate analyzer 700 can include a max design speed of 200 units per minute when producing a widget “abc” and a max design speed of 100 units per minute when producing a widget “xyz,” and the rate analyzer 700 evaluates the first equipment speed in consideration of the widget being produced therein (e.g., as indicated by active SKU and/or package format information as defined in the potential setpoint speeds 710 and other information within line definition 125). Accordingly, the rate analyzer 700 can determine, based on the line definition 125, active SKU and/or package format information, that the first equipment is currently directed towards the widget xyz and, therefore, the rate analyzer 700 should evaluate the first equipment speed based on the widget xyz max design speed of 100 units/minute (e.g., as opposed to the widget abc max design speed of 200 units/minute).

In one example, the rate analyzer 700 analyzes machine speed data and determines that a equipment set to a max speed will perform with less efficiency as compared to efficiency achieved by the same equipment when set to a lower speed. This is shown in the example data within Table 1. The 30 parts-per-minute (ppm) speed setpoint results in a greater capacity (27 ppm) than the 40 ppm speed setpoint (26 ppm). Thus, the output speed setpoint 714 by the rate analyzer 700 would be 30 ppm.

Furthermore, upon determining that the max speed is less efficient than the lower speed, the rate analyzer 700 may further analyzes the equipment data 110 to identify a source of the inefficiency. For example, the rate analyzer 700 identifies equipment faults 716 that disproportionately increase between the lower speed and the max speed. Thus, the optimization setting 726 output by the rate analyzer 700 may also include a fault-list 718 that indicates a potential maintenance operation that would improve the capacity of a given equipment.

In at least one embodiment, the rate analyzer 700 may determine one or more optimal speeds as the speed setpoint 714 by calculating a highest effective speed of a piece of equipment 104 or conveyor 106. In one or more embodiments, optimal speed determination can include, but is not limited to: 1) calculating failure rates experienced by a machine or conveyor at each of one or more set-point speeds; 2) calculating effective speeds based on the calculated failure rates, the effective speeds being a direct function of equipment speed and availability; and 3) identifying a highest effective speed from the calculated effective speeds, the highest effective speed determining the optimal speed.

In one or more embodiments, the rate analyzer 700 may perform one or more increasing failure identifications to determine, for a piece of equipment or conveyor, one or more faults that are increasing disproportionately with increasing speeds, thereby decreasing an effective speed of the equipment or conveyor. In at least one embodiment, fault-list 718 may include, but is not limited to: 1) faults found to be decreasing the effective speed (e.g., “bottle necking” the effective speed) of a piece of equipment or conveyor; and 2) data and/or metadata necessary for identifying the piece of equipment or conveyor.

In one example, the rate analyzer 700 determines, for a given equipment, an optimal speed (e.g., a most effective speed) equal to about 75% of the machine's maximum speed. In the same example, the rate analyzer 700 executes an increasing failure identification process to assess why the equipment's optimal speed is less than the equipment's maximum speed. Continuing the same example, the rate analyzer 700 identifies that a particular equipment part (or sensor) demonstrates increasing fault trends at speed setpoints above the optimal speed, and the rate analyzer 700 flags the machine part in the fault list 718 for further investigation and maintenance (e.g., by production line personnel).

### Machine Configuration Analysis

Where the rate analyzer 700 analyzes the entirety of the production line 102, the output speed setpoint 714 in optimization settings 726 for a given equipment may not be the greatest capacity for that equipment, but instead the greatest possible capacity that will not result in an inefficient (e.g., starved, blocked, or otherwise faulted) operation of downstream and/or upstream equipment. Thus, the rate analyzer 700 provides a holistic optimized control of the production line 102. The rate analyzer 700 may also be combined with the bottle neck analyzer discussed herein such that the output speed setpoints from the rate analyzer 700 do not cause a bottleneck downstream in the production line 102.

Thus, the rate analyzer 700 may perform one or more equipment configuration analyses to determine ideal equipment speed set-points and/or recipe parameters that maximize equipment availability throughout the entire production line 102. The recipe parameter relates to the recipe across the entire production line 102. In one or more embodiments, equipment configuration analysis includes, but is not limited to: 1) determining if a recipe parameter is set to a non-ideal value; 2) calculating an expected and/or an actual variation in equipment availability associated with the non-ideal value; 3) determining if the machine or conveyor availability exceeds an ideal value availability experienced under a current ideal parameter value; 4) upon determining that the machine or conveyor availability exceeds the ideal value availability, confirming the non-ideal value as the new ideal value; and 5) providing output including, but not limited to: A) a list of exceptions and/or critical exceptions identified during the equipment configuration analyses; B) one or more deviating current recipe parameters; and C) one or more alerts, such as, for example, alerts generated in response to flagging and logging a critical exception.

In various embodiments, the equipment configuration analysis can include evaluation of equipment data 110 including, but not limited to, equipment fault data 716 and machine recipe parameters as defined in line definition 125. In one or more embodiments, as part of a equipment configuration analysis performed by the rate analyzer 700, the system may formulate an optimal recipe by automatically identifying an ideal set of recipe parameter values for each equipment per package format using historical equipment data. In at least one embodiment, formulating the optimal recipe can include, but is not limited to: 1) analyzing equipment or conveyor performance over a predefined period; 2) comparing current equipment or conveyor availability against an ideal equipment or conveyor availability associated with ideal recipe parameters; and 3) upon determining that the current equipment or conveyor availability statistically varies from the ideal machine or conveyor availability, identifying and logging any variations between current recipe parameters and the ideal recipe parameters. In at least one embodiment, if the system determines that machine or conveyor availability under current recipe parameters exceeds equipment or conveyor availability under currently defined ideal recipe parameters, the system may automatically re-define the ideal recipe parameters using the current recipe parameters.

In one or more embodiments, the output of the rate analyzer 700, including the speed setpoint 714, is tracked and documented. In at least one embodiment, by tracking and documenting the speed setpoint changes, the rate analyzer may compare the controlled speed setpoint 714 against one or more critical thresholds 720 defining upper and/or lower bounds of a controlled parameter value. In one or more embodiments, if a parameter value exceeds or falls below the one or more critical thresholds 720, the rate analyzer 700 may detect, flag, and log the change as a critical exception. In at least one embodiment, upon detecting a critical exception, the rate analyzer 700 may automatically generate and transmit an alert 722 to users and/or other system elements, the alert 722 can include, but is not limited to, a summary of the critical exception and identifying information for a machine or conveyor associated with the critical exception.

In one example, the rate analyzer 700 may receive a set of current recipe parameters defined by the equipment state data 724 for each equipment 104. In the same example, the rate analyzer 700 may compare the current recipe parameters defined in the equipment state data 724 to a set of predefined designed recipe parameters 728, and may identify and log current state parameters 724 that deviates from corresponding designed state parameters 728. Parameters, as used with respect to state data 724 refers to any operating setpoints of the given equipment as currently operating on the production line 102. Designed state parameters 728 refers to operating setpoints of the given equipment as intended in a fully functional, no faulty equipment state of the production line 102, such as that as designed and first installed in an assumingly correct install. Continuing the same example, the rate analyzer 700 may compare the deviating current recipe parameters of the equipment state data 724 to one or more critical thresholds 720, and may flag and log, as critical exceptions, any deviating current parameters that exceed or fall below the one or more critical thresholds. In the same example, the rate analyzer 700 may automatically generate and transmit one or more alerts 722 summarizing any logged critical exceptions.

In at least one embodiment, the rate analyzer 700 may be used in combination with a simulation tool, described below, to model and evaluate output production line setpoints output by the various analyzers discussed herein. The rate analyzer 700, and optionally in conjunction with the simulator tool discussed below, may generate rankings of the combinations and parameter setpoint changes based on impacts to production line throughput. In one example, the rate analyzer 700 detects that a parameter change to a current recipe has been provided to the system (e.g., by a production line operator, automated controller, etc.), and transmits transmit both the current recipe and a proposed recipe, incorporating the parameter change, to the simulation tool. In the same example, the simulation tool generates and executes simulations of production lines operating according to each recipe. Continuing the same example, the simulation tool obtains output from the simulations, including calculated throughput values associated with each recipe. In the same example, the simulation tool, or another system element described herein, outputs a ranking of the recipes based on highest calculated throughput, and the recipe change tracking system defines a new ideal recipe based on the highest ranked recipe.

### Bottleneck Identification

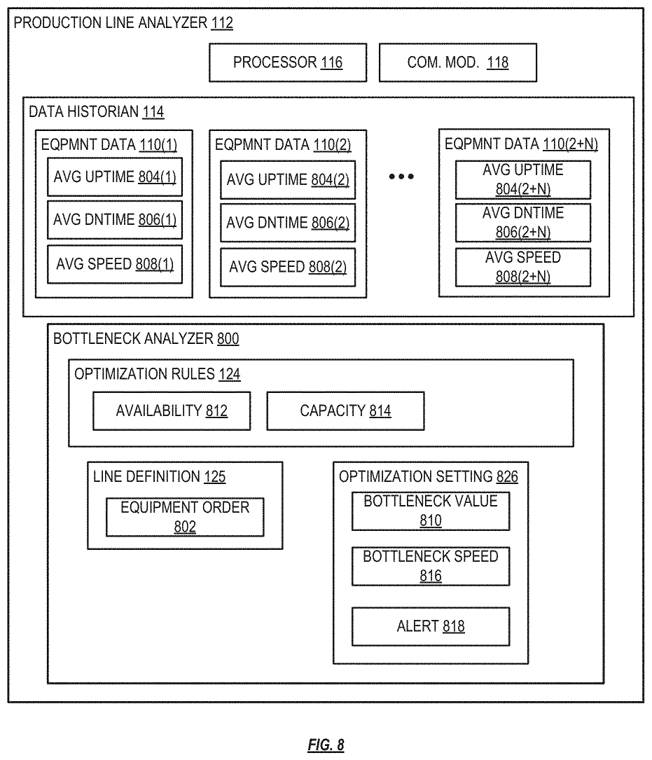

FIG. 8 depicts a bottleneck analyzer 800 which is a component of analyzer 122 of FIG. 1, in embodiments. The bottleneck analyzer 800 includes computer readable instructions that form at least a portion of the optimization rules 124 and, when executed by the processor 116, cause the processor 116 to implement the functionality of the bottleneck analyzer 800 discussed herein. For example, the bottleneck analyzer 800 analyzes current equipment state data to determine production line speeds and downtimes, and identify bottlenecks on the production line 102. In various embodiments, the bottleneck analyzer 800 may identify bottlenecks (e.g., underperforming equipment) based on analyses of equipment speeds, faults, and other data. In one or more embodiments, by performing bottleneck identification, the present system may advantageously provide for prioritization of speed increase and downtime reductions on particular elements of the production line 102 such that the production line 102 is debottlenecked in a most impactful manner. In at least one embodiment, identification of bottlenecking production line equipment may be desirable, because speed increases and downtime decreases for production line equipment that is not contributing to production line bottlenecking can undesirably increase the severity of existing production line bottlenecking.

For example, a production line may include five pieces of equipment (e.g., equipment 104) operating in sequence, the third piece of equipment of which, unbeknownst to a line operator, is most contributive to bottlenecking of the production line. To increase production line throughput, the operator, or production line analyzer 112, may increase speed and decrease downtime of the second piece of equipment. However, because the third piece of equipment is most contributive to bottlenecking, the increased throughput of the second piece of equipment may only serve to worsen production line bottlenecking, because the third piece of equipment may become increasingly blocked, thereby causing the fourth and fifth pieces of equipment to become increasingly starved.

In another example, a production line may include five pieces of equipment (e.g., equipment 104) operating in sequence, the third piece of equipment of which is most contributive to production line bottlenecking. In the same example, an embodiment of the bottleneck analyzer 800 may analyze equipment (e.g., equipment 104) and conveyor (e.g., conveyor 106) performance of the production line and identify that the third piece of equipment is an outright bottleneck (e.g., a bottleneck most contributive to production line bottlenecking). To increase production line throughput, a line operator (or the production line analyzer 112) may increase speed and decrease downtime of the third piece of equipment, thereby debottlenecking the production line and improving throughput by reducing blockage of the third piece of equipment and reducing starvation of the fourth and fifth pieces of equipment.

In one or more embodiments, to analyze production line equipment, the bottleneck analyzer 800 may process one or more line definitions (e.g., line definition 125). In at least one embodiment, the line definition includes an equipment order 802 processing allows the system to establish production line configuration, such as, for example, the order in which equipment 104 receives inputs and provide outputs to and from each other (such as, but not limited to, via conveyor(s) 106). In at least one embodiment, the bottleneck analyzer 800 received equipment data 110 including equipment state data including average uptime 804 and average downtime 806 from each piece of equipment 104 (such as from the PLC 108). In at least one embodiment, the bottleneck analyzer 800 received equipment data 110 including equipment speed data including average speed 808 from each piece of equipment 104 (such as from the PLC 108). The average uptime 804, average downtime 806, and average speed 808 may be time-series data such that individual pieces of data from the same equipment, and different equipment, may be correlated in time to one another. The bottleneck analyzer 800 may not be limited to average uptime 804, average downtime 806, and average speed 808 in its analysis, and may receive any other equipment data 110 from the PLCs 108 that, for the given application, identifies status of a bottleneck on the production line 102.

Based on the equipment data 110, the bottleneck analyzer 800 outputs an optimization setting 826 (which is an example of the optimization setting 126 of FIG. 1). The optimization setting 826 may include a bottleneck value 810 for at least one equipment 104 along the production line 102. In at least one embodiment, the bottleneck value 810 includes a list of the plurality of equipment 104 along the production line 102 sorted by the bottleneck value of each equipment, as determined by the bottleneck analyzer 800. In one or more embodiments, to quantify the bottleneck value 810 of each equipment 104, the bottleneck analyzer 800 may determine the availability 812 for each equipment of the plurality of equipment based on the average uptime 804 and the average downtime 806 of each equipment; and then determine the capacity 814 for each equipment of the plurality of equipment based on the availability 812 and the average speed 808 of each equipment. The availability 812 may be the same as availability 708 discussed above, and determined using equation 1, above.

In embodiments, the bottleneck analyzer 800 utilizes the equipment order 802 to identify parallel equipment (e.g., equipment 104(3) and 104(4)) and serial equipment and analyzes each parallel equipment different from the serial equipment. For example, the bottleneck analyzer 800 may identify the capacity of parallel equipment by serializing the parallel equipment by multiplying the average availability 812 of all parallel equipment by the sum of the average speed 808 of each parallel equipment. Further, in at least some embodiments, when the parallel equipment has the lowest capacity, the bottleneck analyzer 800 may quantify the bottleneck value 810 of the parallel equipment by identifying one of the parallel equipment having the lowest individual capacity.

Table 2, below, shows an example of quantifying a bottleneck value 810 for a production line having an equipment order of: rewinder, logsaw, wrapper A in parallel with wrapper B, bundler, and palletizer.

TABLE 2
Bottleneck Example:

| | | | Wrapper | Wrapper | Wrappers | | |
|---|---|---|---|---|---|---|---|
| Machine | Rewinder* | Logsaw | A | B | (serialized) | Bundler | Palletizer |
| Availability | 79% | 95% | 72% | 74% | n/a | 82% | 98% |
| Avg. Speed | 162 | 150 | 90 | 73 | n/a | 145 | 145 |
| Capacity | 127 | 143 | 65 | 54 | 119 | 118 | 142 |

In Table 2, the “Wrappers (serialized)” column includes the capacity of the wrappers after serialization of the parallel wrappers A and B. The capacity of the serialized wrappers is 119, which is calculated based on ((72*74)/2)*(65+54).

The output bottleneck value 810 may be the capacity 814 of each equipment. Furthermore, if the output bottleneck value 810 is a list, then, in the example of table 2, the bundler would be prioritized as having the most-impactful bottleneck. Wrapper B would then be the second on the list because the capacity of the serialized wrappers is the second-lowest, and then the capacity of the individualized wrapper B is the lowest out of the serialized wrappers.

In at least one embodiment, the optimization setting 126 may include one or more speed bottleneck determinations 816 that identify one or more elements of a production line operating at a slowest rate. In one or more embodiments, to generate a speed bottleneck determinations 816, the bottleneck tool may apply one or more algorithmic techniques to analyze maximum speeds of equipment along a production line and identify one or more machines operating at a comparatively slower rate. In one or more embodiments, processes and techniques for formulating speed bottleneck determinations may exclude equipment downtime from a set of analyzed factors.

In various embodiments, the bottleneck analyzer 800 may quantify the bottleneck value 810 based on the downtime information 806 to identify one or more elements of a production line experiencing the greatest magnitude of downtime. In at least one embodiment, the bottleneck analyzer 800 calculates the average downtime 806 based on one or more algorithmic techniques to: 1) analyze percentages of time each machine of a production line is blocked, starved, and/or faulted in its computations and/or performance; 2) identify any inflection points in the production line where a probability of being starved is greater than a probability of being blocked; and 3) identify any inflection points where a probability of being blocked is greater than a probability of being starved. In one or more embodiments, the bottleneck analyzer 800 may identify equipment disposed at each inflection point, and determine that the identified equipment is a downtime bottleneck. In one or more embodiments, processes and techniques for identifying the bottleneck analyzer 800 may exclude equipment speed from a set of analyzed factors.

In various embodiments, the bottleneck analyzer 800 quantify the bottleneck value 810 based on one or more outright bottleneck determinations to identify one or more elements of a production line that most contribute to production line bottlenecking. In at least one embodiment, the bottleneck analyzer 800 may apply one or more algorithmic techniques to analyze equipment speed and downtime and identify one or more pieces of equipment most contributive to production line bottlenecking. In one or more embodiments, by including an outright bottleneck determination in the bottleneck value 810, the system may advantageously prioritize efforts for speed and downtime improvement to one or more pieces of equipment where such efforts will provide the most relief to production line bottlenecking. In other words, in at least one embodiment, the bottleneck value 810 may represent equipment to be prioritized in speed and downtime improvements efforts.

In at least one embodiment, the bottleneck value 810 may include, but is not limited to, speed, downtime, and outright bottleneck determinations, each determination including equipment and production line-identifying data. In at least one embodiment, the bottleneck value 810 may be organized into ranked lists, ranking being determined based on bottleneck severity (e.g., slowest rate, greatest downtime, etc.). In one or more embodiments, by providing bottleneck determinations, the system may identify production line equipment most contributive to speed, downtime, and/or outright bottlenecking, thereby advantageously providing insights by which production maintenance may be prioritized.

The optimization setting 826 may further include one or more alerts 818, particularly when the bottleneck value 810 exceeds a predefined threshold. The alert 818 may be transmitted to the production line analyzer 112, or another device, such as handheld tablets, e-mail, or other devices used by operators while managing the production line 102

### Loss Analyzer

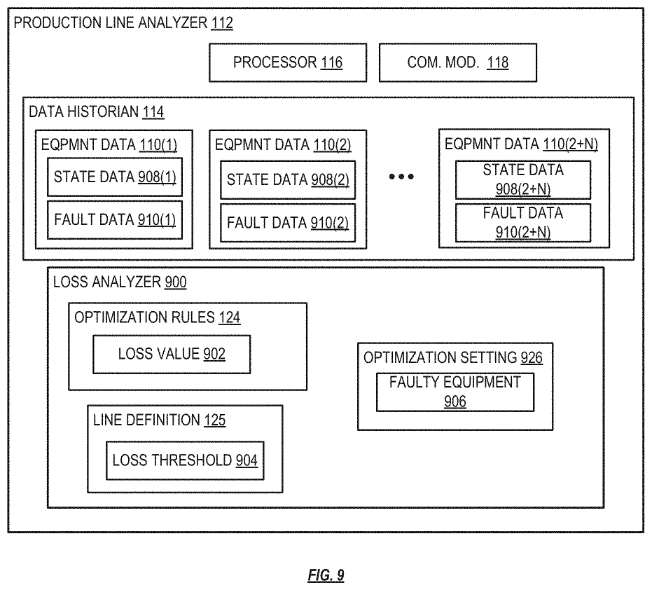

FIG. 9 depicts a loss analyzer 900 which is a component of analyzer 122 of FIG. 1, in embodiments. The loss analyzer 900 includes computer readable instructions that form at least a portion of the optimization rules 124 and, when executed by the processor 116, cause the processor 116 to implement the functionality of the loss analyzer 900 discussed herein. For example, the loss analyzer 900 quantifies a failure-specific loss associated with a first piece of equipment 104 resulting in restricted output from the production line. The loss analyzer 900 may, when the failure-specific loss value 902 breaches a loss threshold 904, defined in the line definition 125, output optimization settings 926 (which are an example of optimization settings 126 of FIG. 1) that identifies faulty equipment 906 (e.g., a list thereof) that result in the failure-specific loss at the first piece of equipment.

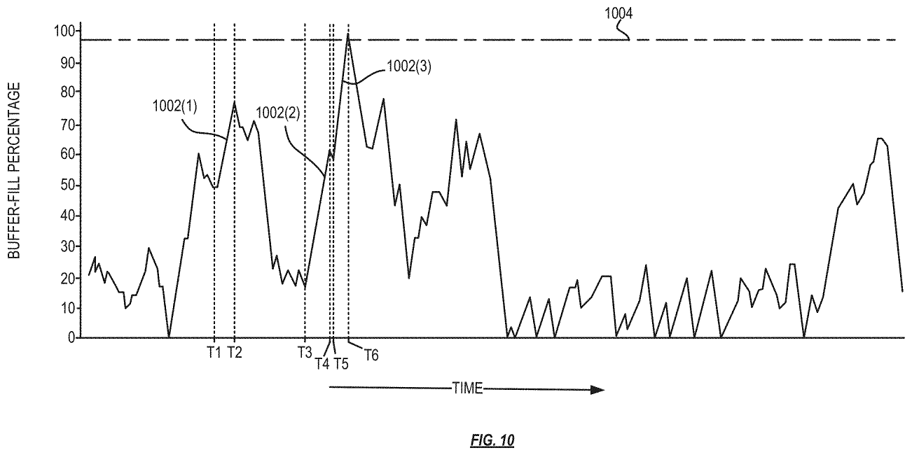

In at least one embodiment, the loss analyzer 900 analyzes equipment state data 908 from a first equipment to identify an equipment state condition (e.g., the loss value 902) that breaches the loss threshold 904. In an example where the first equipment is a buffer-type equipment, the equipment state data 908 may include time-series buffer-fill level data. FIG. 10 depicts a graph 1000 showing example time-series buffer-fill data, which is an example of the equipment state data 908 of FIG. 9, in embodiments. The Y-axis shows buffer fill percentage, the X-axis shows time. The units of time for graph 1000 may be any unit, or interval, at which equipment data 110 is received from the PLC(s) 108, and/or any pre-processing of such data such as interpolation of various time intervals to longer or shorter time interval granularity.

To determine the failure-specific loss value 902, in the example of FIG. 10 related to a buffer-type equipment, the loss analyzer 900 may identifying one or more positive gradients 1002 within the buffer-fill level that breach a buffer-full threshold 1004, the buffer-full threshold corresponding to the loss threshold 904. Graph 1000 shows a first positive gradient 1002(1) between times T1 and T2, a second positive gradient 1002(2) between times T3 and T4, and a third positive gradient 1002(3) between times T5 and T6 that collectively add up to breach fault threshold 1004 (which is 96% full, in the example of FIG. 10). A positive gradient, as referred to herein, includes buffer fill level data that increases the buffer fill at a first time and does not include a corresponding negative buffer-fill level data. Thus, the buffer-type equipment may be a first-in-first-out buffer. The loss analyzer 900 may disregard positive-gradient-attributing portions of the buffer-fill level data that have corresponding negative-gradient-attributing portions of the buffer-fill level data.

The loss analyzer 900 may then identify one or more faulty equipment 906, as one or more downstream equipment (as defined in the line definition 125) from the buffer-type equipment (e.g., the equipment that produced the buffer-fill data of FIG. 10), having at least one fault code in received fault data 910, each fault code time-correlated to one or more of the positive gradients 1002.

### Simulation Engine

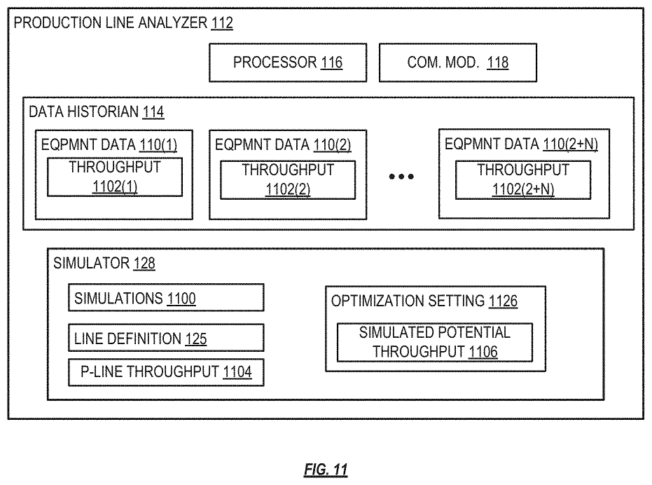

Referring to FIG. 1, the production line analyzer 112 may also include a simulator 128. The simulator 128 may be implemented internally to the production line analyzer 112, or may be external thereto (such as within a cloud computing environment, or on an external edge device). The simulator 128 may include computer readable instructions that, when executed by a processor (e.g., processor 116), implement the functionality of the simulator 128 discussed herein. FIG. 11 depicts the simulator 128 in greater detail, in embodiments. Simulator 128 generates and executes production line simulations to evaluate the impact of idealized and experimental production line definitions and parameters on production line performance (e.g., throughput). In at least one embodiment, the simulator 128 can generate and execute production line simulations 1100. In various embodiments, a simulation 1100 may include one or more programs that provide digital emulations of an ideal production line as defined within the line definition 125. In at least one embodiment, the one or more programs may modify the digitally emulated production line using real-time data, such as the equipment data 110 received from the PLC(s) 108, thereby providing for evaluations of production line performance under experimental conditions. In at least one embodiment, the one or more simulations 1100 may execute a digitally emulated production line to evaluate performance thereof, including, but not limited to, throughput, bottlenecking, etc. In one or more embodiments, by utilizing outputs from analytical and other processes, such as those discussed above with respect to FIGS. 2-10, the simulator 128 may provide highly accurate estimates of real-world throughput that may be demonstrated by a production line.

In one or more embodiments, the simulator 128 receives equipment data 110 associated with each of a plurality of equipment 104 of a production line to-be-simulated (e.g., production line 102). The equipment data 110 may include, but is not limited to: 1) line definition parameters that provide accurate constraints on speed and diverter behavior; 2) historical fault data and speeds; 3) active SKU; and 4) a list of parameters against which a simulation will be run, such as a predefined production time period. In various embodiments, the simulation engine may receive input including insights and data from system tools and processes described herein. Any of the optimization settings 126, 526, 726, 826, and/or 926. For example, the simulator 128 may receive speed, downtime, and outright bottleneck determinations and related data from the bottleneck analyzer 800, and may configure a digital production line emulation to include the same speed, downtime, and bottlenecking conditions. As another example, the simulator 128 may receive speed setpoints from the rate analyzer 700, and may generate a production line simulation incorporating the optimized parameters and speeds.

In at least one embodiment, the simulator 128 may generate a production line simulation representative of an ideal production line. In various embodiments, in an ideal production line simulation, equipment starts and stops may occur with maximum efficiency and/or without product issues, such as, for example, material jams. In one or more embodiments, the production line simulation may include actual parameters for production inefficiencies imported from real production data. In various embodiments, the production line simulation can include parameters for configuring production line factors including, but not limited to: 1) equipment replacements; 2) equipment speeds; 3) production SKU mixes; 4) equipment reliability; and 5) other production line factors and events. In at least one embodiment, the production line simulation may be parametrized for any scenario to validate production schema and parameters prior to implementation in a physical production line. In one or more embodiments, by simulating and evaluating production line parameters prior to implementation, the system may advantageously provide for optimized production line configuration and revision processes that do not require modification of physical production line equipment.

In various embodiments, upon execution of the production line simulation 1100, the simulator 128 may generate optimization settings 1126 including, but not limited to, production line throughput values representative of performance that would be achieved by an actual production line operating based on the received equipment data 110. In at least one embodiment, the simulator 128 may output production line throughput values representative of a production line running ideally from an operational and controls standpoint. In one or more embodiments, the simulator 128 may include a comparison between a current actual production line throughput 1104 (as defined based on the equipment data 110) and a simulated production line throughput (as defined by the simulations 1100 operating based on ideal operating conditions as defined by the line definition 125). For example, equipment data 110 may include a current throughput 1102 for each machine, which is used to determine a current production line throughput 1104, and, upon execution of a simulation 1100, the simulator 128 may generate optimization settings including a simulated production line throughput 1106 representative of throughput that may be obtained under parameters modified from their current state. In the same example, the simulator 128 may also output a ratio and/or other metric comparing the current production line throughput 1104 to the simulated production line throughput 1106. In at least one embodiment, the simulated potential throughput 1106 may be the expected change in throughput against a current or actual throughput 1104. In one or more embodiments, the simulated potential throughput 1106 may be associated with a predefined time period (e.g., one week, month, year, etc. of operation) against which one or more simulations were executed. The optimization settings 1126 may further include modifications 1108, which are control signals that, when received by the production line analyzer 112, implement a change in the control setpoints of one or more equipment 104 to implement an improvement in the throughput of the production line 102.

The simulator may, therefore, output a prioritized list of potential modifications to improve or otherwise modify the production line. This prioritized list may also be based on a desired capital expenditure, so as to allow the line operator to achieve a desired cost-spend in operating the production line.

### Visualization Tool

In at least one embodiment, production line analyzer 112 may further include a visualizer 130. The visualizer 130 may be implemented internally to the production line analyzer 112, or may be external thereto (such as within a cloud computing environment, or on an external edge device). The visualizer 130 may include computer readable instructions that, when executed by a processor (e.g., processor 116), implement the functionality of the visualizer 130 discussed herein. The visualizer 130 may interact with a display of the production line analyzer 112 (not shown) to provide visualizations of outputs described herein, such as any of the above-discussed optimization settings 126, 526, 726, 826, 926, and/or 1126. In one or more embodiments, a visualization tool can process output and other data to generate visualizations of machine performance, fault trends, and other factors and trends.

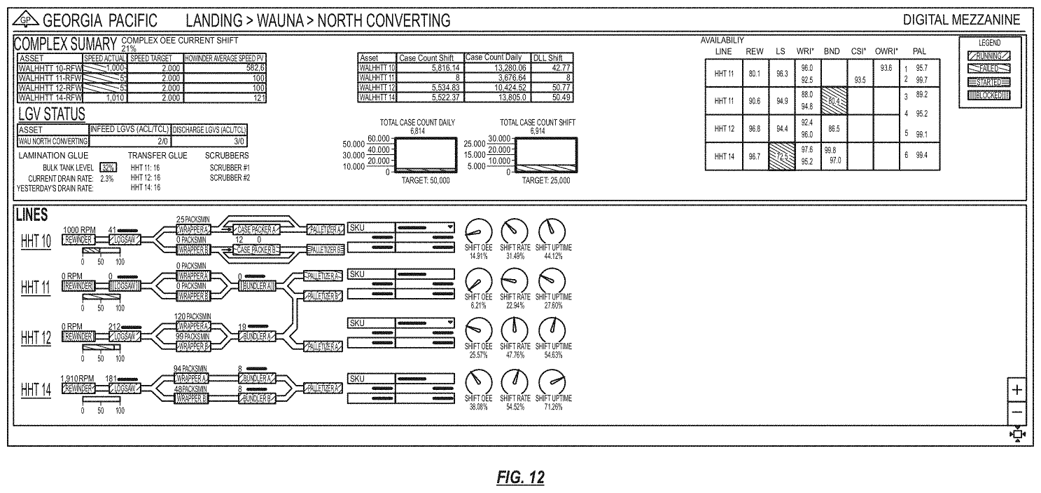

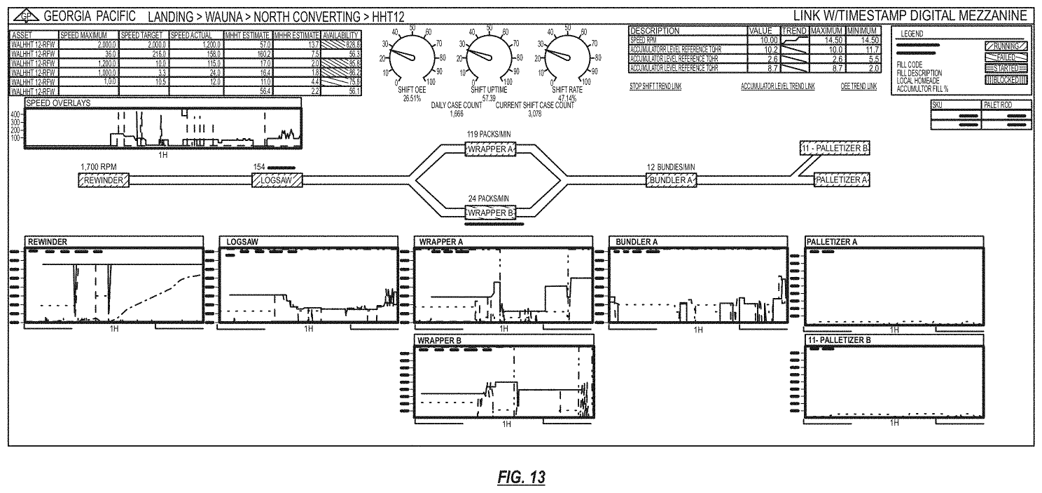

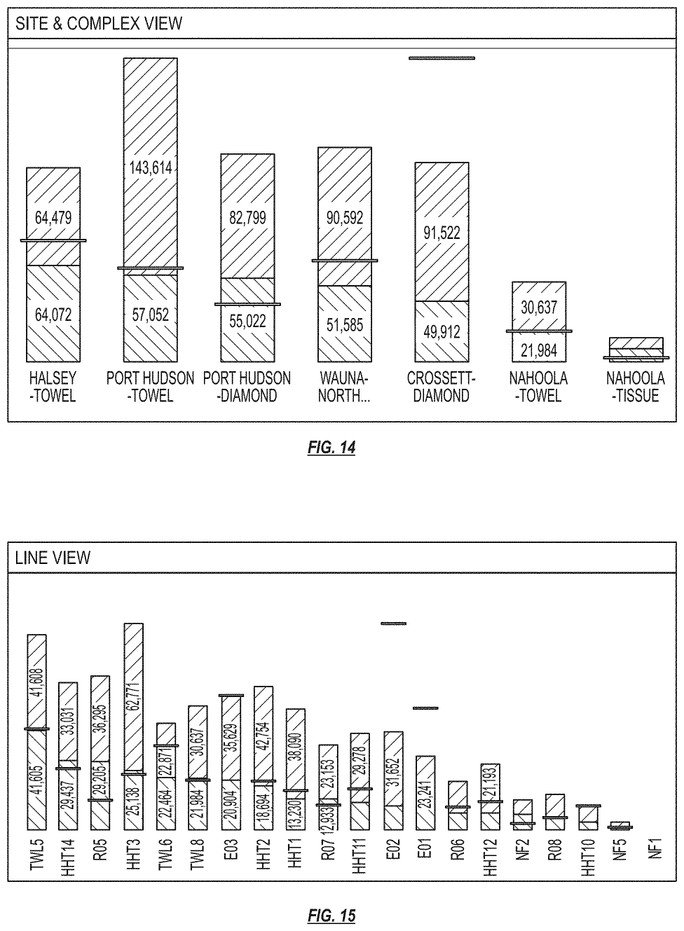

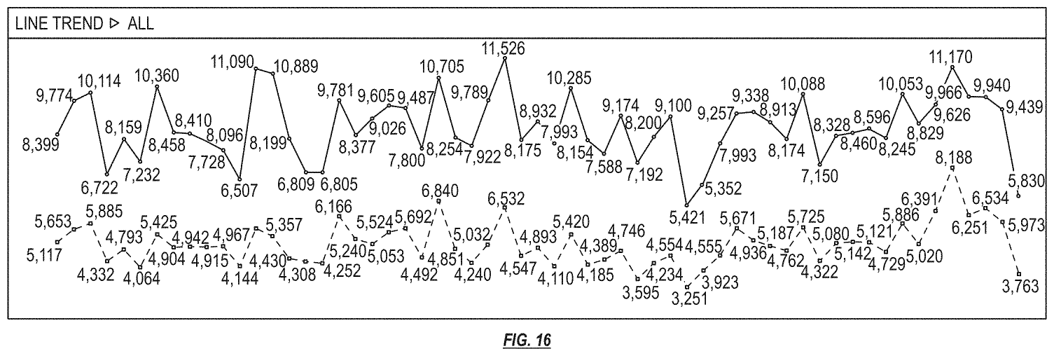

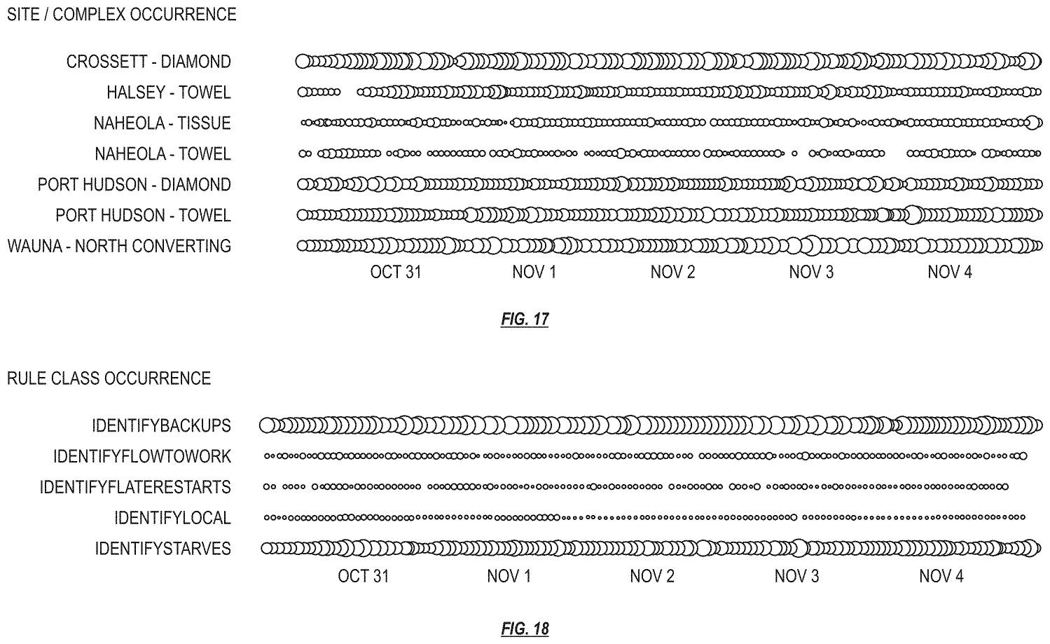

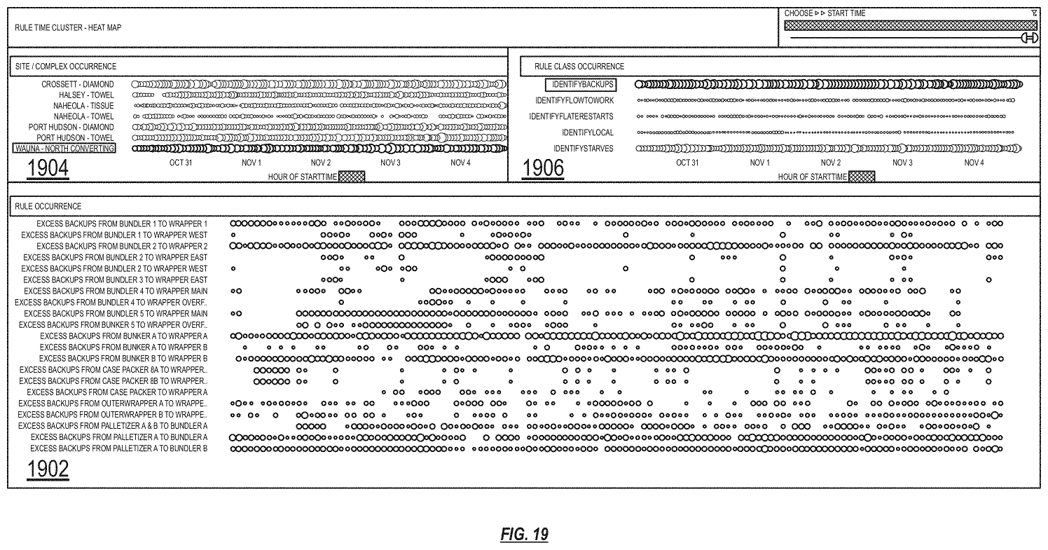

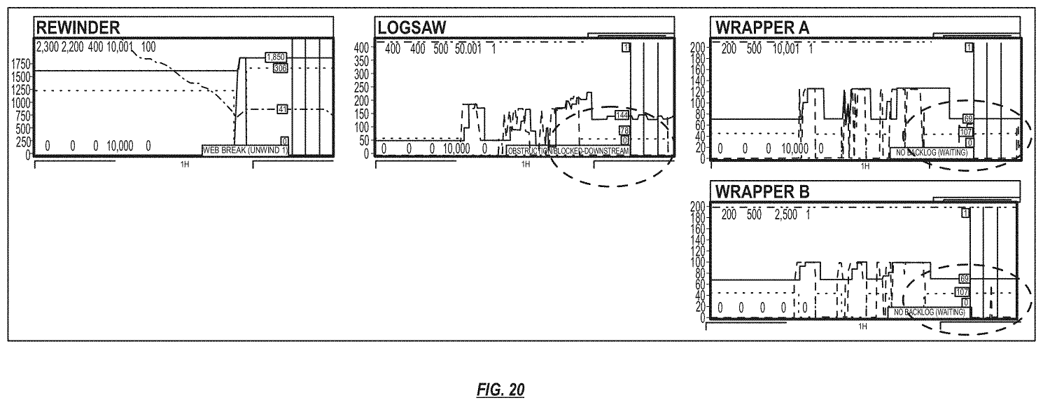

FIGS. 12-19 depict various visualizations output by the visualizer 130, in embodiments. FIG. 12 depicts a summary report that includes the production line layout (e.g., as defined by the line definition 125) to show fault states for each equipment (e.g., as defined by the equipment data 110). FIG. 13 depicts a summary report that includes the production line layout (e.g., as defined by the line definition 125) to show fault states for each equipment (e.g., as defined by the equipment data 110), and further include fault graphs showing fault state times for each equipment. FIG. 14 depicts a multi-site view showing accumulated uptime and downtime (e.g., as defined by the equipment data 110) for all equipment at each of a plurality of production line sites. FIG. 15 depicts production-line view showing accumulated uptime and downtime (e.g., as defined by the equipment data 110) for all equipment in a given production line. The visualizations provided by visualizer 130 may be interactive in that the visualizer may “drill-down” from the site-level (FIG. 14) to the equipment level (FIG. 15) in response to detected interaction (e.g., mouse click, selection with other interaction means (mouse, touchscreen, audio, etc.)) with one or more objects in the displayed visualization by visualizer. FIG. 16 shows a line-trend view of average uptime to downtime. FIG. 17 shows a multi-site view showing fault occurrence levels. Each “dot” corresponds to a given time interval. The dots are larger when more faults occur in the given time interval. FIG. 18 shows a single-site (e.g., single production line) view of the fault occurrence levels including each type of fault that occurs over a given interval. The types of fault may be categorized by the types and examples of optimization settings 126, 526, 726, 826, 926, and/or 1126, discussed above. FIG. 19 illustrates drill-down of the fault occurrence level views of FIGS. 17 and 18. The lower portion 1902 of the display lists fault occurrences for each machine corresponding to the fault type selected in the upper right portion 1906 for the selected site in the upper left portion 1904. Portions 1904 and 1906 are the same as FIGS. 17 and 18, respectively.

### Reporting Tool

In at least one embodiment, production line analyzer 112 may further include a reporter 132. The reporter 132 may be implemented internally to the production line analyzer 112, or may be external thereto (such as within a cloud computing environment, or on an external edge device). The reporter 132 may include computer readable instructions that, when executed by a processor (e.g., processor 116), implement the functionality of the reporter 132 discussed herein. In one or more embodiments, reporter 132 flag any of the optimization settings 126, 526, 726, 826, 926, and/or 1126 discussed herein. In various embodiments, the reporter 132 may perform actions including, but not limited to: 1) receiving and/or retrieving the optimization settings 126, 526, 726, 826, 926, and/or 1126 discussed herein; 2) generating summaries of said optimization settings, including identifying information for equipment related thereto; and 3) transmitting summaries as electronic messages to one or more entities, such as production line operators (e.g., to devices used thereby), support personnel (e.g., to devices used thereby), additional systems, etc. In at least one embodiment, the reporting tool may automatically receive output and other data from tools, processes, and techniques described herein. For example, each tool described herein may automatically transmit outputs, upon their generation, to the reporting tool.

In at least one embodiment, the reporter 132, additionally or in conjunction with the visualizer 130, may include a graphical user interface (GUI) for receiving selections triggering reporter functions. In one or more embodiments, the reporter 132 may embed a GUI, button, or other selection-receiving entity onto GUI's of other tools and systems described herein. For example, a GUI for configuring rate analyzer 700 processes may include a button that, upon selection, causes the rate analyzer 700 to transmit output and related data (e.g., identifiers, input data, etc.) to the reporter 132, which generates and transmits summaries of the information.

In one or more embodiments, the reporter 132 may process metadata tags and other classifiers discussed herein as equipment data 110 (and/or line definition 125) to clearly and uniquely identify equipment, production lines, or other production elements being described in a summary of system output. In at least one embodiment, the reporter 132 may automatically process the metadata included in optimization settings to extract tags and classifiers therein. In various embodiments, based on extracted tags and classifiers, the reporter 132 may automatically retrieve and insert descriptive terms (e.g., associated with the extracted tags and classifiers, and stored within the system) into summaries of system output.

In one or more embodiments, an example of a report generated by the reporter 132 is shown in FIG. 20. In at least one embodiment, the report can include, but is not limited to: 1) a material flow section that includes identifications of production line elements determined to demonstrated faulted performance and/or starved or blocked states; 2) a reliability analysis section that includes identified fault patterns and like-asset comparison outputs; 3) a wins section that describes instances of performance improvement recorded and identified by the system; and 4) other sections corresponding to output of one or more system tools described herein. In various embodiments, the reporting tool can generate the report automatically or in response to receiving a selection. According to one embodiment, the reporting tool (or another system element operatively connected thereto) can transmit a generated report to a display (e.g., an electronic display monitor) that renders the generated report for view by a system operator. In one or more embodiments, the reporting tool is configured to iteratively and/or continuously generate and transmit reports such that one or more displays render real-time analyses and outputs generated by the system.

The report generated by reporter 132 may pinpoint location of potential problems on the production line. For example, where there are a series of block fault data on a first equipment (e.g., logsaw), while a second equipment (e.g., wrapper(s)) is downstream of the first equipment but indicates a starved fault, and a diverter indicates appropriate ratios, then the reporter 132 may flag that there is likely a problem with conveyors between the first equipment and one or both of the second equipment and the diverter.

The reporter 132 may further be responsible for outputting the various alerts discussed herein, as well as trend information associated with each equipment. For example, by producing a trend information over a period to the operator, they can readily identify that the given equipment is faulting on a trajectory to or away from a more severe event which requires shutdown of the production line.

### Description of Various Examples

In one example, the reliability analyzer 500 receives current input data including production line and equipment data 110, from a data historian 114, the data being organized as shown in Table 3, below.

TABLE 3
Reliability Analyzer Example

| | tag_ | |
|---|---|---|
| | numeric_ | |
| raw_tag_name | value | tag_datetime_utc |
| WAU- | 0.0 | year_month_day/ |
| HHT.12.RW.Down_Number.PV | | hours:minutes:seconds |
| WAU- | 169.0 | year_month_day/ |
| HHT.12.RW.Down_Number.PV | | hours:minutes:seconds |
| WAU- | 0.0 | year_month_day/ |
| HHT.12.RW.Down_Number.PV | | hours:minutes:seconds |
| WAU- | 118.0 | year_month_day/ |
| HHT.12.RW.Down_Number.PV | | hours:minutes:seconds |
| WAU- | 0.0 | year_month_day/ |
| HHT.12.RW.Down_Number.PV | | hours:minutes:seconds |
| WAU- | 118.0 | year_month_day/ |
| HHT.12.RW.Down_Number.PV | | hours:minutes:seconds |
| WAU- | 0.0 | year_month_day/ |
| HHT.12.RW.Down_Number.PV | | hours:minutes:seconds |
| WAU- | 118.0 | year_month_day/ |
| HHT.12.RW.Down_Number.PV | | hours:minutes:seconds |
| WAU- | 0.0 | year_month_day/ |
| HHT.12.RW.Down_Number.PV | | hours:minutes:seconds |
| WAU- | 118.0 | year_month_day/ |
| HHT.12.RW.Down_Number.PV | | hours:minutes:seconds |
| WAU- | 0.0 | year_month_day/ |
| HHT.12.RW.Down_Number.PV | | hours:minutes:seconds |
| WAU- | 164.0 | year_month_day/ |
| HHT.12.RW.Down_Number.PV | | hours:minutes:seconds |
| WAU- | 0.0 | year_month_day/ |
| HHT.12.RW.Down_Number.PV | | hours:minutes:seconds |
| WAU- | 167.0 | year_month_day/ |
| HHT.12.RW.Down_Number.PV | | hours:minutes:seconds |
| WAU- | 0.0 | year_month_day/ |
| HHT.12.RW.Down_Number.PV | | hours:minutes:seconds |
| WAU- | 169.0 | year_month_day/ |
| HHT.12.RW.Down_Number.PV | | hours:minutes:seconds |
| WAU- | 0.0 | year_month_day/ |
| HHT.12.RW.Down_Number.PV | | hours:minutes:seconds |
| WAU- | 314.0 | year_month_day/ |
| HHT.12.RW.Down_Number.PV | | hours:minutes:seconds |
| WAU- | 118.0 | year_month_day/ |
| HHT.12.RW.Down_Number.PV | | hours:minutes:seconds |
| WAU- | 0.0 | year_month_day/ |
| HHT.12.RW.Down_Number.PV | | hours:minutes:seconds |
| WAU- | 228.0 | year_month_day/ |
| HHT.12.RW.Down_Number.PV | | hours:minutes:seconds |
| WAU- | 0.0 | year_month_day/ |
| HHT.12.RW.Down_Number.PV | | hours:minutes:seconds |
| WAU- | 228.0 | year_month_day/ |
| HHT.12.RW.Down_Number.PV | | hours:minutes:seconds |
| WAU- | 0.0 | year_month_day/ |
| HHT.12.RW.Down_Number.PV | | hours:minutes:seconds |
| WAU- | 118.0 | year_month_day/ |
| HHT.12.RW.Down_Number.PV | | hours:minutes:seconds |

The equipment data shown in Table 3 is based on preconfigured key indicators and/or tags assigned to sensors and/or programmable logic controllers 108 disposed within the production line 102 and/or equipment 104 therein being analyzed. The “tag_numeric_value” field of Table 3 includes tag values associated with predefined faults detected and recorded in the data historian 114. A “0” in the tag_numeric_value field indicates no fault, and non-zero values indicate occurrence of predefined faults associated with the non-zero values. The equipment data 110 of Table 3 also includes “tag_datetime_utc” fields that include time stamp information representative of when the fault (or no fault) was detected. Thus, the reliability analyzer 500 receives the current input data as an array or other data object that organizes the data based on identifying tag information. The reliability analyzer 500 also receives historical input data including historical production line and/or equipment data (not shown in Table 1) associated with the same production line and/or equipment shown in Table 1 (and organized similarly thereto).

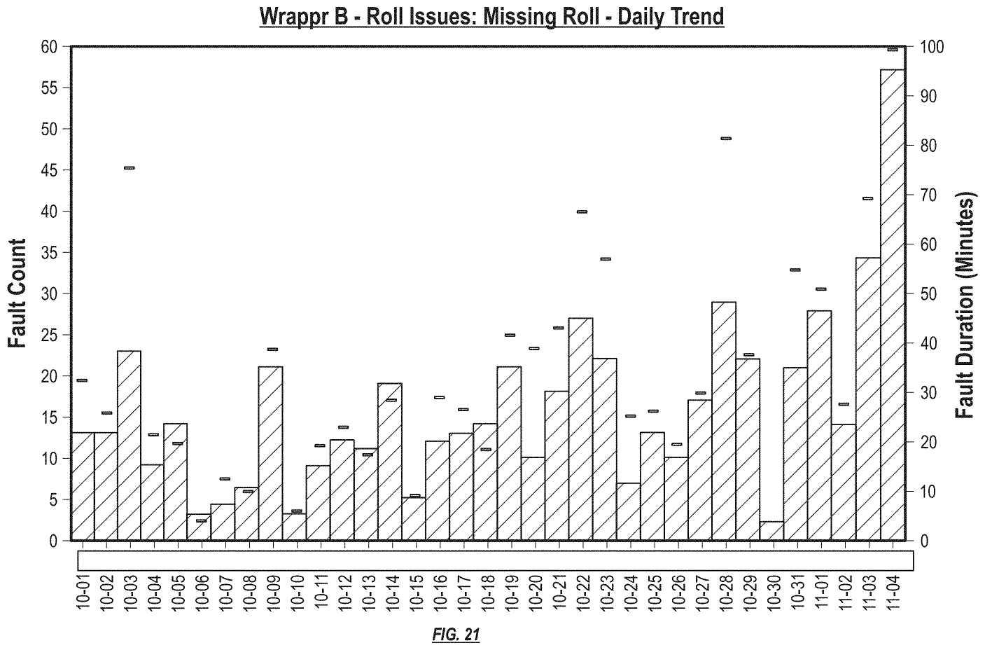

FIG. 21 shows example equipment data 110 in the form of “missing roll” fault counts for a wrapper at daily intervals, in an embodiment. The reliability analyzer 500 analyzes this equipment data 110 to determine fault trend 507. The reliability analyzer 500 evaluates the historical and current equipment data on a fault type-basis, thereby allowing for localization and concentration of fault trends to specific fault types. Accordingly, the data shown in FIG. 21 is associated with a specific “missing roll” fault type; however, the system includes numerous other fault types, as can be appreciated. Furthermore, the reliability analyzer 500, in some embodiments, evaluates the historical and current input data on an equipment-by-equipment basis, thus the data shown in FIG. 21 is associated with a specific piece of equipment (e.g., “HHT11 Wrapper B”).

The reliability analyzer 500 analyzes the historical input data and computes, as an output, a baseline (average) daily high fault trend of 20 fault events. The reliability analyzer 500, e.g., the fault trend analyzer 506, may look at the daily fault count and identify a trend 507 of at least 30 fault events, thereby indicating that the production line and/or equipment therein are demonstrating above-average occurrences of missing roll faults. Thus, in some embodiments, the fault threshold 508 is based on an average value over a threshold period of time prior to a current equipment data interval. Because the reliability analyzer 500 can determine which production line and/or equipment demonstrates the above-average fault performance, the present system can provide for more focused and efficient maintenance operations that address specific issues associated with specific faults, as opposed to inefficient maintenance operations that attempt to address all elements of a production line and/or equipment (e.g., and, therefore, may waste efforts addressing maintenance operations that do not contribute to reducing faulted performance).

As shown in FIG. 21, the reliability analyzer 500 also identifies an increasing fault trend 507 by computing daily actual (or averaged) fault and high fault occurrence totals. The reliability analyzer 500 further evaluates the current input data and determines (and outputs) a baseline daily fault occurrence of 14 faults/day, a daily stops opportunity of 16 stops/day, a daily cases increase of 37 cases/day, and a daily machine uptime opportunity of 40 minutes per day. These outputs may be visualized by visualizer 130 or otherwise reported by reporter 132.

As another example, the reliability analyzer 500 performs a like-asset comparison, as described herein, to compare similar equipment (indicated by similar key and/or tag information in the like-asset definition 504) directed towards similar products (indicated by similar active SKU and/or package format information). The reliability analyzer 500 compares a HHT14 Bundler A to a like-asset HHT14 Bundler B with reference to occurrences of a tipped-roll fault-type. The reliability analyzer 500 receives and evaluates historical and current input equipment data 110 associated with the HHT14 Bundler A and HHT14 Bundler B to generate tipped-roll fault metrics for each piece of equipment. The reliability analyzer 500 compares the tipped-roll fault metrics (e.g., fault occurrences and occurrence frequencies, which may be defined in the fault trend 507) and determines that the HHT14 Bundler A experiences tipped roll-faults at 1.5 times the rate of the like-asset HHT14 Bundler B, thereby indicating that the HHT14 Bundler A demonstrates above average faulted performance levels. The reliability analyzer 500 can output the determination to visualizer 130 and/or reporter 132 for visualization, reporting, and/or alerting. The reliability analyzer 500 can also output the tipped roll-fault metrics of the HHT14 Bundler A including, but not limited to: 1) a baseline daily occurrences metric of 50 daily occurrences; 2) a daily stops opportunity metric of 25 daily stops; 3) a daily machine uptime opportunity metric of 120 minutes; and 4) a daily cases increase metric of 100 cases/day.

Thus, the reliability analyzer 500, via comparing a given equipment to the like asset definition 504, determined that both the HHT14 Bundler A and HHT14 Bundler B demonstrated tipped-roll faults, and also identified the HHT14 Bundler A as demonstrating tipped-roll faults at a higher rate than the HHT14 Bundler B. Based on output of the like-asset comparison, maintenance efforts can be focused towards addressing the most faulty equipment first (e.g., the HHT14 Bundler A) as defined in the faulty equipment list 510 and fault impact list 512, thereby advantageously improving the efficiency of maintenance resource expenditures by directing maintenance efforts to equipment most in need of servicing.

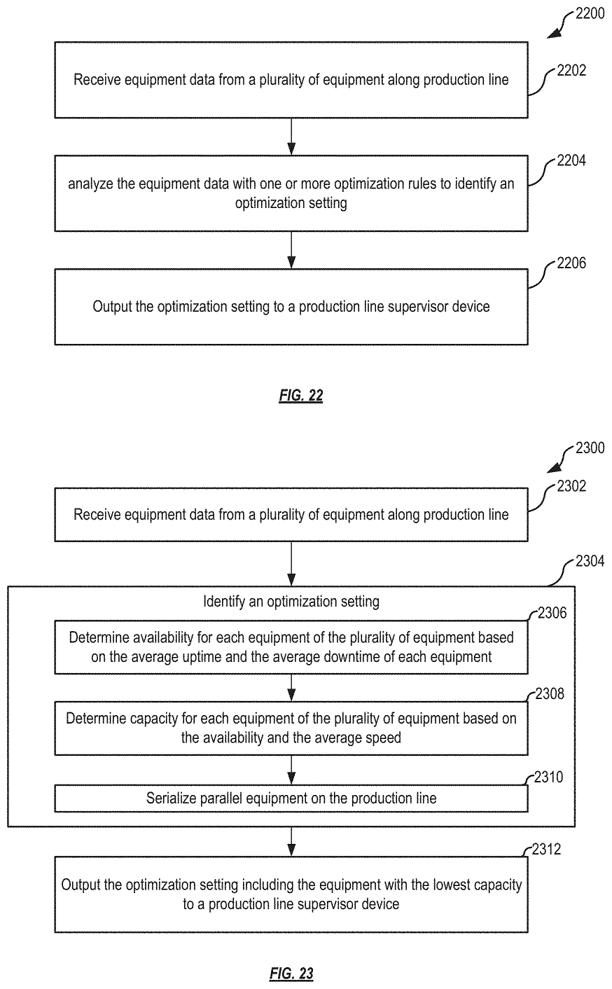

FIG. 22 shows a method 2200 for production line optimization, in embodiments. Method 2200 is, for example, implemented by analyzer 122 (including any of the examples thereof discussed with respect to material flow analyzer 400, reliability analyzer 500, rate analyzer 700, bottleneck analyzer 800, loss analyzer 900, and any combination thereof) via execution by a processor (e.g., processor 116) of the optimization rules 124.

In block 2202, method 2200 receives equipment data from a plurality of equipment along production line. In one example of operation of block 2202, production line analyzer 112 receives equipment data 110 from one or more PLCs 108 (or other equipment 104 and/or conveyors 106).

In block 2204, method 2200 analyzes the equipment data with one or more optimization rules to identify an optimization setting. In one example of operation of block 2204, the analyzer 122 analyzes the received equipment data 110 based on the optimization rules 124 (or any variation thereof as discussed with respect to material flow analyzer 400, reliability analyzer 500, rate analyzer 700, bottleneck analyzer 800, loss analyzer 900, and any combination thereof).

In block 2206, method 2200 outputs an optimization setting to a production line advisor. In one example of operation of block 2206, the optimization setting 126 (or any variation thereof as discussed with respect to material flow analyzer 400, reliability analyzer 500, rate analyzer 700, bottleneck analyzer 800, loss analyzer 900, and any combination thereof) is output to the production line analyzer 112.

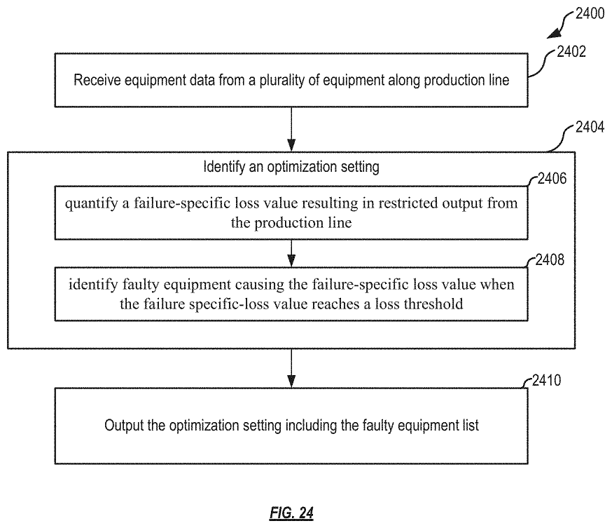

FIG. 23 shows a method 2300 for production line optimization, in embodiments. Method 2300 is an example of method 2200 and is, for example, implemented by analyzer 122 (including the bottleneck analyzer 800) via execution by a processor (e.g., processor 116) of the optimization rules 124. Method 2300 may further include any of the functionality discussed above with respect to bottleneck analyzer 800.

In block 2302, method 2300 receives equipment data from a plurality of equipment along production line. Block 2302 is an example of block 2202. In one example of operation of block 2302, production line analyzer 112 receives equipment data 110 from one or more PLCs 108 (or other equipment 104 and/or conveyors 106). Specifically, in one example of operation of block 2302, the received equipment data includes average uptime 804, average downtime 806, and average speed 808.

In block 2304, method 2300 analyzes the equipment data with one or more optimization rules to identify an optimization setting. Block 2304 is an example of block 2204. In one example of operation of block 2304, the bottleneck analyzer 800 analyzes the equipment data 110, including one or more of average uptime 804, average downtime 806, and average speed 808 to determine optimization setting 126 including one or more of bottleneck value 810, bottleneck speed 816, and alert 818. Block 2304 may include one or more sub-blocks 2306, 2308, and 2310.

In block 2306, method 2300 determine availability for each equipment of the plurality of equipment based on the average uptime and the average downtime of each equipment. In one example of block 2306, the bottleneck analyzer 800 determines the availability 812 for each piece of equipment 104 (and, if needed, conveyor 106) on production line 102. The availability 812 may be determined based on equation 1, above.

In block 2308, method 2300 determines capacity for each equipment of the plurality of equipment based on the availability and the average speed. In one example of block 2308, the bottleneck analyzer 800 determines the capacity 814 for each piece of equipment 104 (and, if needed, conveyor 106) on production line 102 based on the determined availability 812.

In block 2310, method 2300 serializes parallel equipment on the production line for analysis. In one example of operation of block 2310, bottleneck analyzer 800 analyzes a line definition 125 (including, for example, line order 802) to identify and serialize any parallel equipment therein. The serialization may include multiplying the average availability of all parallel equipment by the sum of the average speed of each parallel equipment.

In block 2312, method 2300 outputs an optimization setting. Block 2312 is an example of block 2206. In one example of block 2312, the bottleneck analyzer 800 outputs optimization setting 126 including one or more of bottleneck value 810, bottleneck speed 816, and alert 818. Where block 2310 was implemented, one example of block 2312 includes, when the parallel equipment has the lowest capacity, identifying one of the parallel equipment having the lowest individual capacity.

FIG. 24 shows a method 2400 for production line optimization, in embodiments. Method 2400 is an example of method 2200 and is, for example, implemented by analyzer 122 (including the loss analyzer 900) via execution by a processor (e.g., processor 116) of the optimization rules 124. Method 2400 may further include any of the functionality discussed above with respect to loss analyzer 900.

In block 2402, method 2400 receives equipment data from a plurality of equipment along production line. Block 2402 is an example of block 2202. In one example of operation of block 2402, production line analyzer 112 receives equipment data 110 from one or more PLCs 108 (or other equipment 104 and/or conveyors 106). Specifically, in one example of operation of block 2402, the received equipment data includes state data 908 and fault data 910.

In block 2404, method 2400 analyzes the equipment data with one or more optimization rules to identify an optimization setting. Block 2404 is an example of block 2204. In one example of operation of block 2404, the loss analyzer 900 analyzes the equipment data 110, including one or more of state data 908 and fault data 910 to determine optimization setting 126 including faulty equipment 906. Block 2404 may include one or more sub-blocks 2406 and 2408.

In block 2406, method 2400 quantifies a failure-specific loss value resulting in restricted output from the production line. In one example of block 2406, the loss analyzer 900 quantifies the loss value 902. In one specific example, the equipment state data including time-series buffer-fill level data for a buffer-type equipment. To quantify the loss value 902 in block 2406, the loss analyzer 900 may identify one or more positive gradients within the buffer-fill level that breach a buffer-full threshold defined by loss threshold 904, the buffer-full threshold corresponding to the loss threshold 904.

In block 2408, method 2400 identifies faulty equipment causing the failure-specific loss value when the failure specific-loss value reaches a loss threshold. In one example of block 2408, the loss analyzer 900 identifies the faulty equipment 906. In one specific example, the loss analyzer 900 identifies one or more faulty equipment 906 as one or more downstream equipment (as indicated in line definition 125) from the buffer-type equipment, having at least one fault code each time-correlated to one or more of the positive gradients. In an embodiment, block 2408 may include disregarding positive-gradient-attributing portions of the buffer-fill level data that have corresponding negative-gradient-attributing portions of the buffer-fill level data.

In block 2410, method 2400 outputs the optimization setting including the faulty equipment list. Block 2410 is an example of block 2206. In one example of block 2406, the loss analyzer 900 outputs optimization setting 126 including the faulty equipment 906.

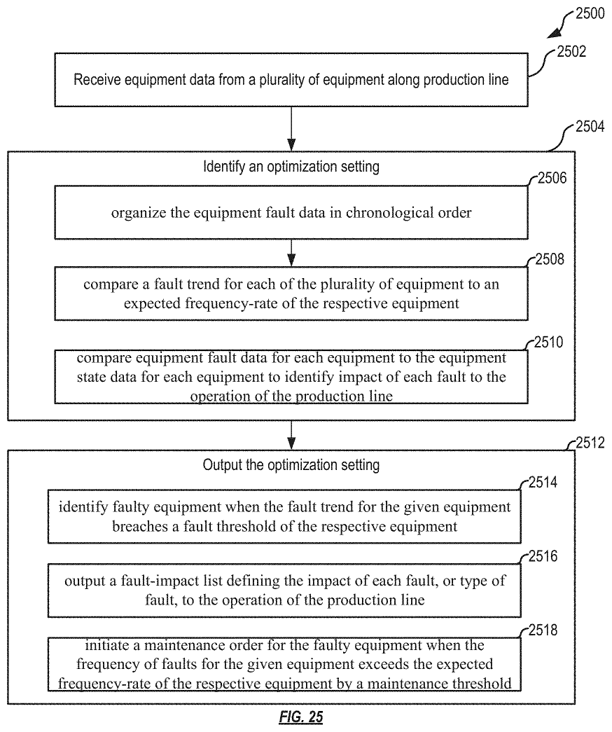

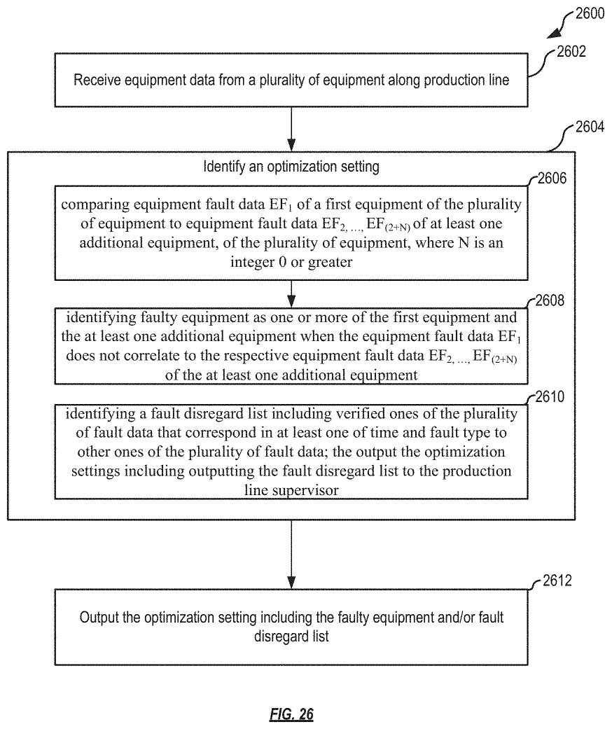

FIG. 25 shows a method 2500 for production line optimization, in embodiments. Method 2500 is an example of method 2200 and is, for example, implemented by analyzer 122 (including the reliability analyzer 500) via execution by a processor (e.g., processor 116) of the optimization rules 124. Method 2500 may further include any of the functionality discussed above with respect to reliability analyzer 500.

In block 2502, method 2500 receives equipment data from a plurality of equipment along production line. Block 2502 is an example of block 2202. In one example of operation of block 2502, production line analyzer 112 receives equipment data 110 from one or more PLCs 108 (or other equipment 104 and/or conveyors 106). Specifically, in one example of operation of block 2502, the received equipment data includes fault data 502 and state data 514.

In block 2504, method 2500 analyzes the equipment data with one or more optimization rules to identify an optimization setting. Block 2504 is an example of block 2204. In one example of operation of block 2504, the reliability analyzer 500 analyzes the equipment data 110, including one or more of fault data 502 and state data 514 to determine optimization setting 126 including one or more of faulty equipment list 510, fault impact list 512, and alert 516. Block 2504 may include one or more sub-blocks 2506, 2508, and 2510.

In block 2506, method 2500 organizes the received equipment fault data in chronological order. In one example of block 2506, the reliability analyzer 500 organizes the fault data 502 in chronological order.

In block 2508, method 2500 compares a fault trend for each of the plurality of equipment to an expected frequency-rate of the respective equipment. In one example of block 2508, the reliability analyzer 500 compares a fault trend 507 for each of the plurality of equipment 104 to an expected frequency-rate (e.g., fault threshold 508) of the respective equipment.

In block 2510, method 2500 compares equipment fault data for each equipment to the equipment state data for each equipment to identify impact of each fault to the operation of the production line. In one example of block 2510, the reliability analyzer 500 compares equipment fault data 502 for each equipment 104 to the equipment state data 514 for each equipment to identify impact of each fault in the fault data 502 to the operation of the production line 102.

In block 2512, method 2500 outputs the optimization setting including the faulty equipment list. Block 2510 is an example of block 2206. In one example of block 2512, the reliability analyzer 500 outputs optimization setting 126 including one or more of faulty equipment list 510, fault impact list 512, and alert 516. Block 2512 may include one or more of sub-blocks 2514, 2516, and 2518.

In block 2514, method 2500 identifies faulty equipment when the fault trend for the given equipment breaches a fault threshold of the respective equipment. In one example of block 2514, the reliability analyzer 500 identifies the faulty equipment in the faulty equipment list 510 when a given equipment's fault trend 507 breaches a fault threshold 508.

In block 2516, method 2500 outputs a fault-impact list defining the impact of each fault, or type of fault, to the operation of the production line. In one example of block 2516, the reliability analyzer 500 outputs the fault-impact list 512.

In block 2518, method 2500 initiate a maintenance order for the faulty equipment when the frequency of faults for the given equipment exceeds the expected frequency-rate of the respective equipment by a maintenance threshold. In one example of block 2518, the reliability analyzer 500 outputs the alert 516 that initiates a maintenance order for the faulty equipment when the frequency of faults for the given equipment exceeds the expected frequency-rate of the respective equipment by a maintenance threshold.

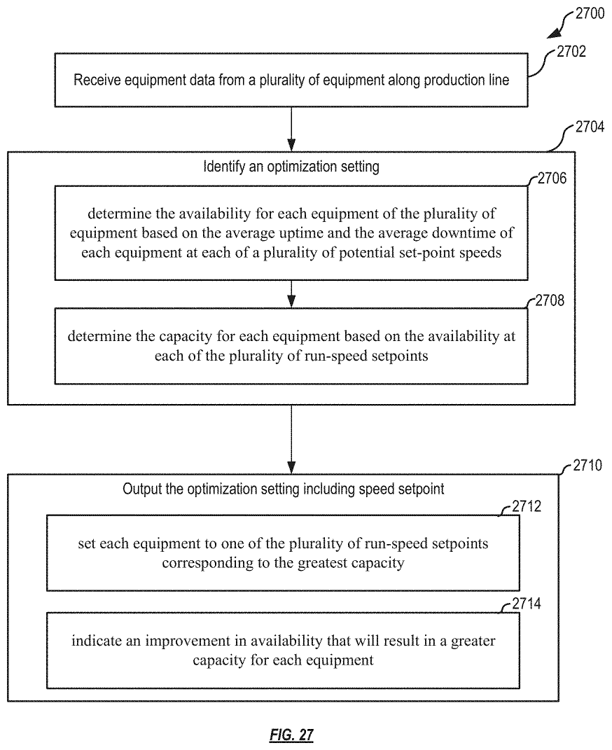

FIG. 26 shows a method 2600 for production line optimization, in embodiments. Method 2600 is an example of method 2200 and is, for example, implemented by analyzer 122 (including the flow analyzer 400) via execution by a processor (e.g., processor 116) of the optimization rules 124. Method 2600 may further include any of the functionality discussed above with respect to the flow analyzer 400.

In block 2602, method 2600 receives equipment data from a plurality of equipment along production line. Block 2602 is an example of block 2202. In one example of operation of block 2602, production line analyzer 112 receives equipment data 110 from one or more PLCs 108 (or other equipment 104 and/or conveyors 106). Specifically, in one example of operation of block 2602, the received equipment data includes fault data 402.

In block 2604, method 2600 analyzes the equipment data with one or more optimization rules to identify an optimization setting. Block 2604 is an example of block 2204. In one example of operation of block 2604, the flow analyzer 400 analyzes the equipment data 110, including fault data 402, to determine optimization setting 126 including one or more of faulty equipment list 406 and fault data disregard list 408. Block 2604 may include one or more sub-blocks 2606, 2608, and 2610.

In block 2606, method 2600 compares equipment fault data EF₁ of a first equipment of the plurality of equipment to equipment fault data EF₂, . . . , EF_{(2+N)} of at least one additional equipment, of the plurality of equipment, where N is an integer 0 or greater. In one example of block 2606, the flow analyzer 400 analyzes fault data 402 of a first equipment 104, and compares it to fault data 402 of another equipment 104.

In block 2608, method 2600 identifies faulty equipment as one or more of the first equipment and the at least one additional equipment when the equipment fault data EF₁ does not correlate to the respective equipment fault data EF₂, . . . , EF_{(2+N)} of the at least one additional equipment. In one example of block 2608 the flow analyzer 400 identifies the faulty equipment list 406. For example, where the equipment data EF₁ is a starved fault, the at least one additional equipment may be upstream from the first equipment providing the equipment data EF₁. As another example, where the equipment data EF₁ is a blocked fault, the at least one additional equipment may be downstream from the first equipment providing the equipment data EF₁.

In block 2610, method 2600 identifies a fault disregard list including verified ones of the plurality of fault data that correspond in at least one of time and fault type to other ones of the plurality of fault data; the output the optimization settings including outputting the fault disregard list to the production line advisor. In one example of block 2610, the flow analyzer 400 identifies the fault data disregard list 408.

In block 2612, method 2600 outputs the optimization setting including the faulty equipment and/or fault disregard list. In one example of block 2612, the flow analyzer 400 outputs the faulty equipment list 406 and/or fault disregard list 408.

FIG. 27 shows a method 2700 for production line optimization, in embodiments. Method 2700 is an example of method 2200 and is, for example, implemented by analyzer 122 (including the rate analyzer 700) via execution by a processor (e.g., processor 116) of the optimization rules 124. Method 2700 may further include any of the functionality discussed above with respect to the rate analyzer 700.

In block 2702, method 2700 receives equipment data from a plurality of equipment along production line. Block 2702 is an example of block 2202. In one example of operation of block 2702, production line analyzer 112 receives equipment data 110 from one or more PLCs 108 (or other equipment 104 and/or conveyors 106). Specifically, in one example of operation of block 2702, the received equipment data includes average uptime 702, average downtime 704, and average speed 706.

In block 2706, method 2700 determines the availability for each equipment of the plurality of equipment based on the average uptime and the average downtime of each equipment at each of a plurality of potential set-point speeds. In one example of operation of block 2706, the rate analyzer 700 determines availability 708 based on the average uptime 702 ad the average downtime 704 for a plurality of potential setpoint speeds 710 as defined in the line definition 125. The availability 708 may be calculated using equation 1, above.

In block 2708, method 2700 determine the capacity for each equipment based on the availability at each of the plurality of run-speed setpoints. In one example of operation of block 2708, the rate analyzer 700 determines capacity 712 based on the availability 708 calculated for each of the plurality of potential setpoint speeds 710 as defined in the line definition 125.

In block 2710, method 2700 outputs the optimization setting including the speed setpoint. Block 2710 is an example of block 2206. In one example of block 2710, the rate analyzer 700 outputs optimization setting 126 including speed setpoint 714. Block 2710 may include one or more of sub-blocks 2712 and 2714.

In block 2712, method 2700 sets each equipment to one of the plurality of run-speed setpoints corresponding to the greatest capacity. In one example of block 2712, the speed setpoint 714 indicates to set each equipment 104 to a corresponding one of the potential setpoint speeds 710 corresponding to the greatest capacity 712.

In block 2714, method 2700 indicates an improvement in availability that will result in a greater capacity for each equipment. In one example of block 2714, the speed setpoints 714 include potential speed setpoints that indicate an improvement in availability that will result in a greater capacity for each equipment.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a computer.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a computer to perform one specific function or a group of functions.

Those skilled in the art will understand the features and aspects of a suitable computing environment in which aspects of the disclosure may be implemented. Although not required, some of the embodiments of the claimed inventions may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed invention are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the invention is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed inventions will be readily discernible from the description herein, by those of ordinary skill in the art. Many embodiments and adaptations of the disclosure and claimed inventions other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed inventions. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed inventions. In addition, some steps may be carried out simultaneously, contemporaneously, or in synchronization with other steps.

The embodiments were chosen and described in order to explain the principles of the claimed inventions and their practical application so as to enable others skilled in the art to utilize the inventions and various embodiments and with various modifications as are suited to the particular use contemplated. Alternative embodiments will become apparent to those skilled in the art to which the claimed inventions pertain without departing from their spirit and scope. Accordingly, the scope of the claimed inventions is defined by the appended claims rather than the foregoing description and the exemplary embodiments described therein.

The above described features may be combined in any manner without departing from the scope hereof. The below combination of features includes examples of such combinations, where any feature described above may also be combined with any embodiment of the aspects described below.

In an embodiment (A1) of a first aspect, method for production line optimization includes: receiving, from each of a plurality of equipment along the production line, equipment data at each interval of a plurality of intervals, the equipment data including equipment speed data, equipment state data, and equipment fault data; analyzing the equipment data with one or more optimization rules to identify an optimization setting; and, outputting the optimization setting to a production line device for modification of the production line.

(A2) In the embodiment (A1), the analyzing the equipment data includes quantifying a bottleneck value for the plurality of equipment along the production line.

(A3) In any embodiment (A2), the bottleneck value including a list of the plurality of equipment sorted by the bottleneck value.

(A4) In any embodiment (A2), the equipment state data includes average uptime and average downtime of each equipment; the equipment speed data includes average speed; the quantifying the bottleneck value includes: determining availability for each equipment of the plurality of equipment based on the average uptime and the average downtime of each equipment, and determining capacity for each equipment of the plurality of equipment based on the availability and the average speed; and the outputting the optimization setting includes identifying the equipment with the lowest capacity.

(A5) In any embodiment (A4), the method further including identifying parallel equipment based on a production line layout; the determining the capacity includes serializing the parallel equipment by multiplying average availability of all parallel equipment by sum of average speed of each parallel equipment; wherein, when the parallel equipment has the lowest capacity, the identifying the equipment including identifying one of the parallel equipment having the lowest individual capacity.

(A6) In any embodiment (A2), the analyzing the equipment data includes: quantifying a failure-specific loss value resulting in restricted output from the production line; and identifying faulty equipment causing the failure-specific loss value when the failure-specific loss value reaches a loss threshold.

(A7) In any embodiment (A6), the equipment state data includes time-series buffer-fill level data for a buffer-type equipment; the quantifying the failure-specific loss value includes: identifying one or more positive gradients within the buffer-fill level that breach a buffer-full threshold, the buffer-full threshold corresponding to the loss threshold, and identify one or more faulty equipment, as one or more downstream equipment from the buffer-type equipment, having at least one fault code each time-correlated to one or more of the positive gradients; wherein the list of plurality of equipment includes the faulty equipment.

(A8) In any embodiment (A7), the buffer-full threshold being less than 100 percent full.

(A9) In any embodiment (A7)-(A8), the buffer-type equipment being a first-in-first-out buffer; the identifying one or more positive gradients including disregarding positive-gradient-attributing portions of the buffer-fill level data that have corresponding negative-gradient-attributing portions of the buffer-fill level data.

(A10) In any embodiment (A1)-(A9), the analyzing the equipment data including: organizing the equipment fault data in chronological order, and comparing a fault trend for each of the plurality of equipment to an expected frequency-rate of the respective equipment; the outputting the optimization setting including identifying faulty equipment when the fault trend for a given equipment breaches a fault threshold of the respective equipment.

(A11) In any embodiment (A10), the fault threshold being an expected frequency-rate being based on historical frequency of faults for the given equipment.

(A12) In any embodiment (A10)-(A11), the fault threshold being an expected frequency-rate being based on historical frequency of faults for additional equipment (i) located at the production line or another production line, and (ii) being a like-asset to the given equipment.

(A13) In any embodiment (A10)-(A12), the outputting the optimization setting including automatically initiating a maintenance order for the faulty equipment when the fault trend frequency of faults for the given equipment exceeds the expected frequency-rate of the respective equipment by a maintenance threshold.

(A14) In any embodiment (A1)-(A13), the analyzing the equipment data includes comparing equipment fault data for each equipment to the equipment state data for each equipment to identify impact of each fault to operation of the production line; the outputting the optimization setting includes outputting a fault-impact list defining the impact of each fault, or type of fault, to the operation of the production line.

(A15) In any embodiment (A1)-(A14), the analyzing the equipment data including: comparing equipment fault data EF₁ of a first equipment of the plurality of equipment to equipment fault data EF₂, . . . , EF_{(2+N)} of at least one additional equipment, of the plurality of equipment, where N is an integer 0 or greater, and identifying faulty equipment as one or more of the first equipment and the at least one additional equipment when the equipment fault data EF₁ does not correlate to the respective equipment fault data EF₂, . . . , EF_{(2+N)} of the at least one additional equipment; the outputting the optimization setting including identifying the faulty equipment.

(A16) In any embodiment (A15), the equipment fault data EF₁ including a starved fault; the at least one additional equipment being upstream from the first equipment.

(A17) In any embodiment (A15)-(A16), the equipment fault data EF₁ including a blocked fault; the at least one additional equipment being downstream from the first equipment.

(A18) In any embodiment (A15)-(A17), the method further including identifying a fault disregard list including verified ones of the fault data that correspond in at least one of time and fault type to other ones of the fault data; the output the optimization settings including outputting the fault disregard list to the production line device.

(A19) In any embodiment (A1)-(A18), the equipment state data including average uptime and average downtime of each equipment; the equipment speed data including average speed; the analyzing the equipment data including: determining availability for each equipment of the plurality of equipment based on the average uptime and the average downtime of each equipment at each of a plurality of potential set-point speeds, and determining capacity for each equipment based on the availability at each of the plurality of potential set-point speeds; the outputting the optimization setting including setting each equipment to one of the plurality of potential set-point speeds corresponding to the greatest capacity.

(A20) In any embodiment (A19), the outputting the optimization setting further including indicating an improvement in availability that will result in a greater capacity for each equipment.

(A21) In any embodiment (A1)-(A20), the method further including: modifying an initial model of the production line based on the equipment data to yield a simulated production line model; simulating, using the simulated production line model a plurality of potential modifications to the production line; and, outputting a prioritized list of the potential modifications based on the optimization rules.

(A22) In any embodiment (A21), the prioritized list being prioritized based on capital expenditure.

(A23) In any embodiment (A1)-(A22), the method including any of the functionality discussed above, and/or any feature discussed below with respect to the second aspect and the third aspect.

In an embodiment (B1) of a second aspect, a system for production line optimization, includes: a data historian storing equipment data, received from each of a plurality of equipment along the production line at each interval of a plurality of intervals, the equipment data including equipment speed data, equipment state data, and equipment fault data; an analyzer including computer readable instructions that, when executed by a processor, cause the processor to: analyze the equipment data with one or more optimization rules to identify an optimization setting, and output the optimization setting to a production line device for modification of the production line.

(B2) In the embodiment (B1), the computer readable instructions implementing a bottleneck analyzer that, when executed, further cause the processor to quantify a bottleneck value for the plurality of equipment along the production line.

(B3) In any embodiment (B2), the bottleneck value including a list of the plurality of equipment sorted by the bottleneck value.

(B4) In any embodiment (B2)-(B3), the equipment state data including average uptime and average downtime of each equipment; the equipment speed data including average speed; the instructions implementing the bottleneck analyzer causing the processor to quantify the bottleneck value by: determining availability for each equipment of the plurality of equipment based on the average uptime and the average downtime of each equipment, and determining capacity for each equipment of the plurality of equipment based on the availability and the average speed; and the instructions to outputting the optimization setting causing the processor to identify the equipment with the lowest capacity.

(B5) In any embodiment (B4), the computer readable instructions further causing the processor to identify parallel equipment based on a production line layout; the instructions that cause the processor to determine the capacity including instructions that cause the processor to serialize the parallel equipment by multiplying average availability of all the parallel equipment by sum of average speed of each of the parallel equipment;

wherein, when the parallel equipment has the lowest capacity, the instructions that cause the processor to identify the equipment including instructions that cause the processor to identify one of the parallel equipment having the lowest individual capacity.

(B6) In any embodiment (B1)-(B5), the instructions implementing a loss analyzer that, when executed by the processor, cause the processor to implement the analyzing the equipment data by: quantifying a failure-specific loss value resulting in restricted output from the production line; and identifying faulty equipment causing the failure-specific loss value when the failure-specific loss value reaches a loss threshold.

(B7) In any embodiment (B6), the equipment state data including time-series buffer-fill level data for a buffer-type equipment; the quantifying the failure-specific loss value including: identifying one or more positive gradients within the buffer-fill level that breach a buffer-full threshold, the buffer-full threshold corresponding to the loss threshold, and identify one or more faulty equipment, as one or more downstream equipment from the buffer-type equipment, having at least one fault code each time-correlated to one or more of the positive gradients; wherein the list of equipment includes the faulty equipment.

(B8) In any embodiment (B7), the buffer-full threshold being less than 100 percent full.

(B9) In any embodiment (B7)-(B8), the buffer-type equipment being a first-in-first-out buffer; the identifying one or more positive gradients including disregarding positive-gradient-attributing portions of the buffer-fill level data that have corresponding negative-gradient-attributing portions of the buffer-fill level data.

(B10) In any embodiment (B1)-(B9), the instructions implementing a reliability analyzer that, when executed by the processor, cause the processor to: implement the analyzing the equipment data by: organizing the equipment fault data in chronological order, and comparing a fault trend for each of the plurality of equipment to an expected frequency-rate of the respective equipment; implement the outputting the optimization setting by identifying faulty equipment when the fault trend for a given equipment breaches a fault threshold of the respective equipment.

(B11) In any embodiment (B10), the fault threshold being an expected frequency-rate being based on historical frequency of faults for a given equipment.

(B12) In any embodiment (B10)-(B11), the fault threshold being an expected frequency-rate being based on historical frequency of faults for additional equipment (i) located at the production line or another production line, and (ii) being a like-asset to the given equipment.

(B13) In any embodiment (B10)-(B12), the reliability analyzer, when executed by the processor, implementing the outputting the optimization setting by automatically initiating a maintenance order for the faulty equipment when fault trend frequency of faults for the given equipment exceeds the expected frequency-rate of the respective equipment by a maintenance threshold.

(B14) In any embodiment (B1)-(B13), the instructions implementing a reliability analyzer that, when executed by the processor, cause the processor to: implement the analyzing the equipment data by comparing equipment fault data for each equipment to the equipment state data for each equipment to identify impact of each fault to operation of the production line; and implement the outputting the optimization setting by outputting a fault-impact list defining the impact of each fault, or type of fault, to the operation of the production line.

(B15) In any embodiment (B1)-(B14), the instructions implementing a flow analyzer that, when executed by the processor, cause the processor to: implement the analyzing the equipment data by: comparing equipment fault data EF₁ of a first equipment of the plurality of equipment to equipment fault data EF₂, . . . , EF_{(2+N)} of at least one additional equipment, of the plurality of equipment, where N is an integer 0 or greater, and identifying faulty equipment as one or more of the first equipment and the at least one additional equipment when the equipment fault data EF₁ does not correlate to the respective equipment fault data EF₂, . . . , EF_{(2+N)} of the at least one additional equipment; and implement the outputting the optimization setting including identifying the faulty equipment.

(B16) In any embodiment (B15), the equipment fault data EF₁ including a starved fault; the at least one additional equipment being upstream from the first equipment.

(B17) In any embodiment (B15)-(B16), the equipment fault data EF₁ including a blocked fault; the at least one additional equipment being downstream from the first equipment.

(B18) In any embodiment (B15)-(B17), the flow analyzer, when executed by the processor, further causing the processor to identify a fault disregard list including verified ones of the fault data that correspond in at least one of time and fault type to other ones of the fault data; and implement the output the optimization settings by outputting the fault disregard list to the production line device.

(B19) In any embodiment (B1)-(B18), the equipment state data including average uptime and average downtime of each equipment; the equipment speed data including average speed; the instructions implementing a rate analyzer that, when executed by the processor, cause the processor to: implement the analyzing the equipment data by: determining availability for each equipment of the plurality of equipment based on the average uptime and the average downtime of each equipment at each of a plurality of potential set-point speeds, and determining capacity for each equipment based on the availability at each of the plurality of potential set-point speeds; and implement the outputting the optimization setting including setting each equipment to one of the plurality of potential set-point speeds corresponding to the greatest capacity.

(B20) In any embodiment (B19), the rate analyzer, when executed by the processor, causing the processor to implement the outputting the optimization setting by further indicating an improvement in availability that will result in a greater capacity for each equipment.

(B21) In any embodiment (B1)-(B20), the instructions implementing a simulator that, when executed by the processor, cause the processor to: modify an initial model of the production line based on the equipment data to yield a simulated production line model; simulate, using the simulated production line model a plurality of potential modifications to the production line; and, output a prioritized list of the potential modifications based on the optimization rules.

(B22) In any embodiment (B21), the prioritized list being prioritized based on capital expenditure.

(B23) In any embodiment (B1)-(B22), the system including further computer readable instructions that, when executed by the processor, cause the processor to implement any of the functionality discussed above, and/or any feature discussed above with respect to the first aspect and below with respect to the third aspect.

In an embodiment (C1) of a third aspect, a system for production line optimization, includes: a data historian storing equipment data, received from each of a plurality of equipment along the production line at each interval of a plurality of intervals, the equipment data including equipment speed data, equipment state data, and equipment fault data; and a simulator as computer readable instructions that, when executed by a processor, cause the processor to: modify an initial model of the production line based on the equipment data to yield a simulated production line model; simulate, using the simulated production line model a plurality of potential modifications to the production line; and, output a prioritized list of the potential modifications based on optimization rules.

(C2) In the embodiment (C1), the system including further computer readable instructions that, when executed by the processor, cause the processor to implement any of the functionality discussed above, and/or any feature discussed above with respect to the first aspect or second aspects.

What is claimed is:

1. A method for production line optimization, comprising:
receiving, from each of a plurality of equipment along the production line, equipment data including equipment speed data, equipment state data, and equipment fault data;
analyzing the equipment data with one or more optimization rules to identify an optimization setting; and,
outputting the optimization setting to a production line device for modification of the production line.

2. The method of claim 1, the analyzing the equipment data including quantifying a bottleneck value for the plurality of equipment along the production line.

3. The method of claim 2,
the equipment state data including average uptime and average downtime of each equipment;
the equipment speed data including average speed;
the quantifying the bottleneck value including:
determining availability for each equipment of the plurality of equipment based on the average uptime and the average downtime of each equipment, and
determining capacity for each equipment of the plurality of equipment based on the availability and the average speed; and
the outputting the optimization setting including identifying the equipment with the lowest capacity.

4. The method of claim 3, further comprising identifying parallel equipment based on a production line layout;
the determining the capacity including serializing the parallel equipment by multiplying average availability of all parallel equipment by sum of average speed of each parallel equipment;
wherein, when the parallel equipment has the lowest capacity, the identifying the equipment including identifying one of the parallel equipment having the lowest individual capacity.

5. The method of claim 2, the analyzing the equipment data including:
quantifying a failure-specific loss value resulting in restricted output from the production line; and
identifying faulty equipment causing the failure-specific loss value when the failure-specific loss value reaches a loss threshold.

6. The method of claim 5,
the equipment state data including time-series buffer-fill level data for a buffer-type equipment;
the quantifying the failure-specific loss value including:
identifying one or more positive gradients within the buffer-fill level that breach a buffer-full threshold, the buffer-full threshold corresponding to the loss threshold, and
identifying one or more faulty equipment, as one or more downstream equipment from the buffer-type equipment, having at least one fault code each time-correlated to one or more of the positive gradients;
wherein the list of plurality of equipment includes the faulty equipment.

7. The method of claim 6,
the buffer-type equipment being a first-in-first-out buffer;
the identifying one or more positive gradients including disregarding positive-gradient-attributing portions of the buffer-fill level data that have corresponding negative-gradient-attributing portions of the buffer-fill level data.

8. The method of claim 1,
the analyzing the equipment data including:
organizing the equipment fault data in chronological order, and
comparing a fault trend for each of the plurality of equipment to an expected frequency-rate of the respective equipment;
the outputting the optimization setting including identifying faulty equipment when the fault trend for a given equipment breaches a fault threshold of the respective equipment.

9. The method of claim 8, the fault threshold being one or more of:
an expected frequency-rate being based on historical frequency of faults for the given equipment, and
an expected frequency-rate being based on historical frequency of faults for additional equipment (i) located at the production line or another production line, and (ii) being a like-asset to the given equipment.

10. The method of claim 8, the outputting the optimization setting including automatically initiating a maintenance order for the faulty equipment when the fault trend frequency of faults for the given equipment exceeds the expected frequency-rate of the respective equipment by a maintenance threshold.

11. The method of claim 1,
the analyzing the equipment data including comparing equipment fault data for each equipment to the equipment state data for each equipment to identify impact of each fault to operation of the production line;
the outputting the optimization setting including outputting a fault-impact list defining the impact of each fault, or type of fault, to the operation of the production line.

12. The method of claim 1,
the analyzing the equipment data including:
comparing equipment fault data EF₁ of a first equipment of the plurality of equipment to equipment fault data EF₂, . . . , EF_{(2+N)} of at least one additional equipment, of the plurality of equipment, where N is an integer 0 or greater, and
identifying faulty equipment as one or more of the first equipment and the at least one additional equipment when the equipment fault data EF₁ does not correlate to the respective equipment fault data EF₂, . . . , EF_{(2+N)} of the at least one additional equipment;
the outputting the optimization setting including identifying the faulty equipment.

13. The method of claim 12, wherein:
when the equipment fault data EF₁ includes a starved fault, the at least one additional equipment is upstream from the first equipment, and
when the equipment fault data EF₁ including a blocked fault, the at least one additional equipment is downstream from the first equipment.

14. The method of claim 1,
the equipment state data including average uptime and average downtime of each equipment;
the equipment speed data including average speed;
the analyzing the equipment data including:
determining availability for each equipment of the plurality of equipment based on the average uptime and the average downtime of each equipment at each of a plurality of potential set-point speeds, and
determining capacity for each equipment based on the availability at each of the plurality of potential set-point speeds;
the outputting the optimization setting including setting each equipment to one of the plurality of potential set-point speeds corresponding to the greatest capacity.

15. The method of claim 1, further comprising:
modifying an initial model of the production line based on the equipment data to yield a simulated production line model;
simulating, using the simulated production line model a plurality of potential modifications to the production line; and,
outputting a prioritized list of the potential modifications based on the optimization rules.

16. The method of claim 15, the prioritized list being prioritized based on capital expenditure.

17. A system for production line optimization, comprising:
a data historian storing equipment data, received from each of a plurality of equipment along the production line at each interval of a plurality of intervals, the equipment data including equipment speed data, equipment state data, and equipment fault data;
an analyzer including computer readable instructions that, when executed by a processor, cause the processor to: analyze the equipment data with one or more optimization rules to identify an optimization setting, and output the optimization setting to a production line device for modification of the production line.

18. The system of claim 17,
the equipment state data including average uptime and average downtime of each equipment;
the equipment speed data including average speed;
the system further comprising instructions that, when executed, implement a bottleneck analyzer causing the processor to quantify a bottleneck value by:
determining availability for each equipment of the plurality of equipment based on the average uptime and the average downtime of each equipment, and
determining capacity for each equipment of the plurality of equipment based on the availability and the average speed; and
the instructions to outputting the optimization setting causing the processor to identify the equipment with the lowest capacity.

19. The system of claim 17,
the equipment state data including time-series buffer-fill level data for a buffer-type equipment;
the instructions implementing a loss analyzer that, when executed by the processor, cause the processor to implement the analyzing the equipment data by:
quantifying the failure-specific loss value by implementing operations including:
identifying one or more positive gradients within the buffer-fill level that breach a buffer-full threshold, the buffer-full threshold corresponding to the loss threshold, and
identify one or more faulty equipment, as one or more downstream equipment from the buffer-type equipment, having at least one fault code each time-correlated to one or more of the positive gradients;
identifying faulty equipment causing the failure-specific loss value when the failure-specific loss value reaches a loss threshold.

20. The system of claim 17, the instructions implementing a reliability analyzer that, when executed by the processor, cause the processor to:
implement the analyzing the equipment data by comparing equipment fault data for each equipment to the equipment state data for each equipment to identify impact of each fault to operation of the production line; and
implement the outputting the optimization setting by outputting a fault-impact list defining the impact of each fault, or type of fault, to the operation of the production line.

21. The system of claim 17, the instructions implementing a flow analyzer that, when executed by the processor, cause the processor to:
implement the analyzing the equipment data by:
comparing equipment fault data EF₁ of a first equipment of the plurality of equipment to equipment fault data EF₂, . . . , EF_{(2+N)} of at least one additional equipment, of the plurality of equipment, where N is an integer 0 or greater, and
identifying faulty equipment as one or more of the first equipment and the at least one additional equipment when the equipment fault data EF₁ does not correlate to the respective equipment fault data EF₂, . . . , EF_{(2+N)} of the at least one additional equipment; and
implement the outputting the optimization setting including identifying the faulty equipment.

22. The system of claim 17,
the equipment state data including average uptime and average downtime of each equipment;
the equipment speed data including average speed;
the instructions implementing a rate analyzer that, when executed by the processor, cause the processor to:
implement the analyzing the equipment data by:
determining availability for each equipment of the plurality of equipment based on the average uptime and the average downtime of each equipment at each of a plurality of potential set-point speeds, and
determining capacity for each equipment based on the availability at each of the plurality of potential set-point speeds; and
implement the outputting the optimization setting including setting each equipment to one of the plurality of potential set-point speeds corresponding to the greatest capacity.

23. A system for production line optimization, comprising:
a data historian storing equipment data, received from each of a plurality of equipment along the production line at each interval of a plurality of intervals, the equipment data including equipment speed data, equipment state data, and equipment fault data; and
a simulator as computer readable instructions that, when executed by a processor, cause the processor to:
modify an initial model of the production line based on the equipment data to yield a simulated production line model;
simulate, using the simulated production line model a plurality of potential modifications to the production line; and,
output a prioritized list of the potential modifications based on optimization rules.
